(19) United States
(12) Patent Application Publication
(10) Pub. No.: US 2019/0051009 A1
(43) Pub. Date: Feb. 14, 2019

(54) METHODS AND APPARATUS FOR MONITORING AND RESPONDING TO ABNORMAL CONDITIONS AT A CUSTOMER PREMISES SITE

(71) Applicant: Charter Communications Operating, LLC, St. Louis, MO (US)

(72) Inventor: Mark Reimer, Denver, CO (US)

(21) Appl. No.: 15/676,969

(22) Filed: Aug. 14, 2017

(51) Int. Cl. G06T 7/70; H04N 7/18; G06K 9/00

(52) U.S. Cl. CPC G06T 7/70; H04N 7/181; G06K 9/00771; G06K 9/00288; G06T 2207/30232; G06T 2207/30196; G06T 2207/10016

(57) ABSTRACT

Methods and apparatus for monitoring a customer premises, e.g., using video cameras are described. Abnormal conditions are detected and responded to in an automated manner. Objects of interest are identified and current positions of the objects are detected over time based on captured images of the monitored area. If a set of predetermined action conditions corresponding to an object are satisfied, the monitoring system takes an action to correct, e.g., automatically correct, the detected problem and/or the monitoring system generates an alert. Correcting the problem may and sometimes does include automatically shutting off a valve, e.g., a gas or water valve, and/or using a motor to close a door.

### FIELD

The present invention relates to monitoring devices and methods and more particularly to methods and apparatus for using video images to monitor an area, detect conditions which maybe of concern and/or to automatically take action in response to one or more detected conditions.

### BACKGROUND

The Baby Boomer (aged 53-71) and Silent (aged 72+) generations account for one third of the population in the United States. As the population of elderly people increases home renovations are increasing to allow for aging in place, This includes changing the physical characteristics of a home, such as adding ramps, widening doorway, adding a bathroom to the first floor, as well as adding home automation capabilities such as temperature and lighting control.

As an aging population continues to live in the residence of their choice for as long as they are able to, monitoring systems will need to fill the gap where care providers traditionally provided direct supervision in a nursing home or hospice. Many elderly are not in a financial position to be able to afford a full time live-in aid to continuously monitor conditions in the home. In addition many elderly, who wish to remain in their home, do not want an aid for personal privacy or independence reasons.

Unfortunately comprehensive home monitoring solutions for aging in place do not exist today. Today, Personal Emergency Response Systems (PERS), e.g., including a wireless pendant or transmitter that can be activated in an emergency, are used to inadequately fill the need. PERS typically requires the monitored individual to wear a bracelet or wireless pendant and activate the alarm by pushing a button. These PERS devices run on batteries and need to be regularly maintained, e.g., recharged or replaced. In addition, PERS devices are a visible sign of aging that are not fashionable and are embarrassing to wear. In addition, PERS only works when the button is activated, and at times the button may not be in reach on the monitored individual who may have fallen. Thus, many elderly have been resistant to carrying around an emergency wireless pendent or transmitter. In addition, the PERS may not be able to promptly detect abnormal conditions in the home which are going undetected by the elderly person wearing the pendant or transmitter. PERS typically send alerts in response to a live threatening event which has already occurred.

Based on the above discussion there is a need for new method and apparatus of monitoring a customer premises, e.g., a residence of an elderly person's home, in which abnormal conditions can be promptly detected and responded to, e.g., in automated manner, before a property damaging or life threatening event occurs.

### SUMMARY

Methods and apparatus for monitoring, detecting abnormal conditions and responding to the detected abnormal conditions are described. Various embodiments in accordance with the present invention are well suited for monitoring a customer premises, e.g. a home environment of an elderly person and detecting and responding to problems promptly, e.g., in an automated manner, before the problem becomes life threatening or property damaging.

Video cameras are used to monitor identified objects and/or persons, e.g., over time, to detect abnormal conditions, e.g., a stove burner which is on and has been left unattended for a predetermined amount of time, a refrigerator door which has been left open for a predetermined length of time, a faucet which has been left unattended and running for a predetermined length of time, a person that has fallen and remained on the ground for a predetermined length of time. In response to a determination that a detected set of conditions has been satisfied, e.g., based on visual observations captured by one or more cameras over time, in some embodiments, a monitoring system takes an action to correct, e.g., automatically correct the detected abnormal condition, activates an alert and/or sends a message to device, e.g., a contact's cell phone or a relative's cell phone, or system, e.g., an emergency responder system.

In various embodiments, methods and apparatus in accordance with the present invention provide continuous or near continuous monitoring of a premises and notification when potentially dangerous conditions exist, e.g., a water faucet being left on or a range burner left on unattended. In various embodiments, installation within the home is relatively simple to perform and does not require costly modification to existing appliances or renovations to a home, e.g., the home owner does not need to replace the existing faucets with expensive self-shutting off faucets, e.g., as used in commercial establishments.

Various embodiments in accordance with the present invention facilitate an elderly or handicapped person to remain in their home in a safe environment with minimal or no involvement of the person in the monitoring and anomaly detection process.

An exemplary method, in accordance with some embodiments, includes: identifying objects, e.g., door, knob, person, faucet handle, in an image of an area subject to monitoring; determining a current position of at least a first identified object to be monitored; determining if the current position of the first identified object to be monitored is in a first position, said first position being a position in response to which an action is to be taken if first action conditions are satisfied; determining if the first action conditions are satisfied; and in response to determining that the first identified object to be monitored is in the first position and that the first action conditions are satisfied, performing at least one of: i) taking an action to alter a condition at the area subject to monitoring, e.g., automatically operating an electronic water/gas shut off value shutting of supply of water or gas or automatically operating a motor to close a door, or ii) generating an alert.

### BRIEF DESCRIPTION OF THE FIGURES

FIG. 1 is a drawing of an exemplary monitoring, reporting and response system in accordance with an exemplary embodiment.

FIG. 2 is a drawing including a monitored area of a customer premises site at various times, said monitored area including a stove whose knob positions are monitored in accordance with an exemplary embodiment.

FIG. 3 is a drawing including a monitored area of a customer premises site at various times, said monitored area including a stove whose knob positions and burners are monitored in accordance with an exemplary embodiment.

FIG. 4 is a drawing including a monitored area of a customer premises site at various times, said monitored area including a refrigerator whose door positions are monitored in accordance with an exemplary embodiment.

FIG. 5 is a drawing including a monitored area of a customer premises site at various times, said monitored area including a faucet whose faucet handle position is monitored in accordance with an exemplary embodiment.

FIG. 6 is a drawing including a monitored area of a customer premises site at various times, said monitored area including a person whose position with respect to the ground, is monitored in accordance with an exemplary embodiment.

FIG. 7 is a flowchart of an exemplary method of operating a monitoring system to monitor for and detect abnormal conditions in a monitored environment, e.g., an elderly person's home including cameras and identified objected of interest, and to respond to detected abnormal conditions in accordance with an exemplary embodiment.

FIG. 8 is a drawing of an exemplary monitoring system, e.g., a monitoring device, in accordance with an exemplary embodiment.

FIG. 9A is a first part of a flowchart of an exemplary method of detecting conditions, e.g., abnormal conditions, at a monitored site, and responding, in accordance with an exemplary embodiment.

FIG. 9B is a second part of a flowchart of an exemplary method of detecting conditions, e.g., abnormal conditions, at a monitored site, and responding, in accordance with an exemplary embodiment.

FIG. 9 comprises the combination of FIG. 9A and FIG. 9B.

FIG. 10 is a flowchart of an exemplary door action condition satisfaction determination subroutine in accordance with an exemplary embodiment.

FIG. 11 is a flowchart of an exemplary knob action conditions satisfaction determination subroutine in accordance with an exemplary embodiment.

FIG. 12 is a flowchart of an exemplary faucet handle action conditions satisfaction determination subroutine in accordance with an exemplary embodiment.

FIG. 13 is a flowchart of an exemplary person action conditions satisfaction determination subroutine in accordance with an exemplary embodiment.

FIG. 14 is a drawing of exemplary sets of action conditions, e.g., used by action condition satisfaction determination subroutines, in accordance with an exemplary embodiment.

FIG. 15A is a first part of an assembly of components which may be included in an exemplary monitoring system, e.g., a monitoring device, in accordance with an exemplary embodiment.

FIG. 15B is a second part of an assembly of components which may be included in an exemplary monitoring system, e.g., a monitoring device, in accordance with an exemplary embodiment.

FIG. 15C is a third part of an assembly of components which may be included in an exemplary monitoring system, e.g., a monitoring device, in accordance with an exemplary embodiment.

FIG. 15D is a fourth part of an assembly of components which may be included in an exemplary monitoring system, e.g., a monitoring device, in accordance with an exemplary embodiment.

FIG. 15E is a fifth part of an assembly of components which may be included in an exemplary monitoring system, e.g., a monitoring device, in accordance with an exemplary embodiment.

FIG. 15F is a sixth part of an assembly of components which may be included in an exemplary monitoring system, e.g., a monitoring device, in accordance with an exemplary embodiment.

FIG. 15 comprises the combination of FIG. 15A, FIG. 15B, FIG. 15C, FIG. 15D, FIG. 15E and FIG. 15F.

### DETAILED DESCRIPTION

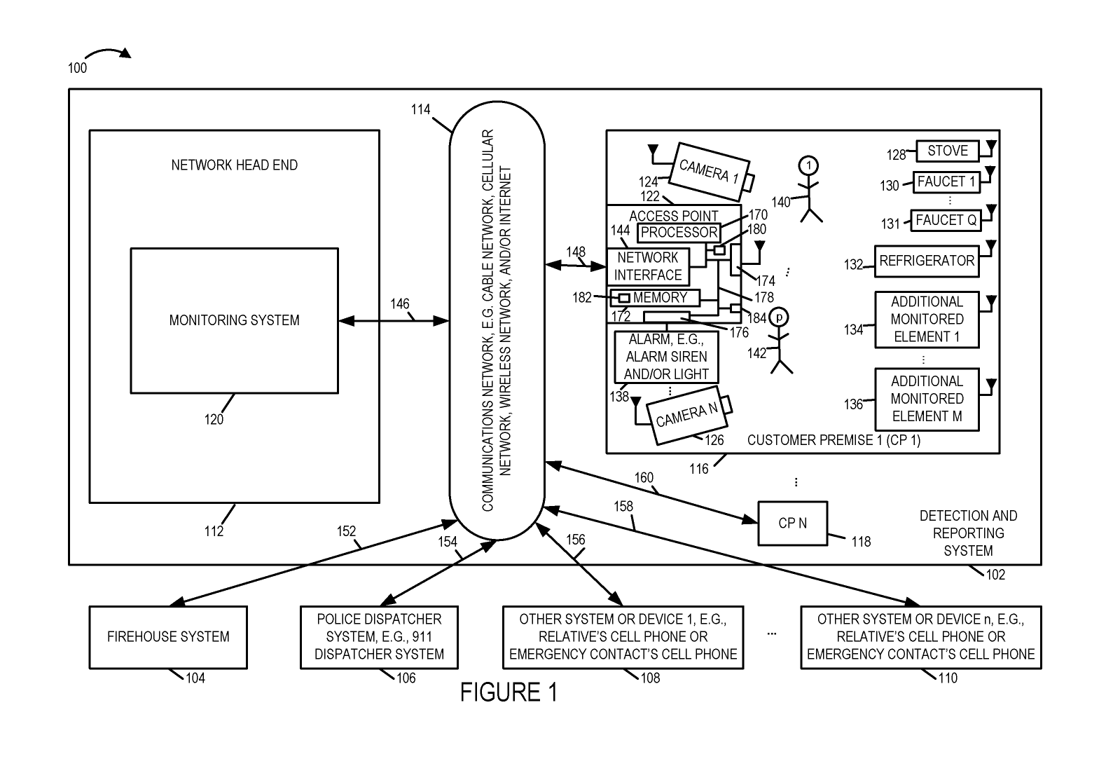

FIG. 1 is a drawing of an exemplary monitoring, reporting and response system 100 in accordance with an exemplary embodiment. Exemplary monitoring reporting and response system 100 includes a detection and reporting system 102, a firehouse system 104, a police dispatcher system 106, e.g., a 911 dispatcher system, an a plurality of additional systems and/or devices (other system 1 or device 1 108, e.g., a relative's cell phone or emergency contact's cell phone, corresponding to customer premises 1, . . . , other system n or device n 110, e.g., a relative's cell phone or emergency contact's cell phone, corresponding to customer premises N), coupled together as shown in FIG. 1. Exemplary detection and reporting system 102 includes a network head end 112 and a plurality of customer premises (customer premises 1 (CP1 116), . . . , customer premises N (CP N 118) coupled together via a communications network 114, e.g., a cable network, cellular network, wireless network, and/or the Internet.

Network head end 112 includes a monitoring system 120 coupled to the communications network 114 via communications link 146. In some embodiments, the monitoring system 120 is located at different site than network head end 120, e.g., a central monitoring system control site which is remote from the network head end and from the customer premises being monitored. In some embodiments, some portions or some functionality of the monitoring system 120 is located within one or more access points, e.g., within access point 122. Customer premises 1 116 includes an access point 122, a plurality of cameras (camera 1 124, . . . , camera N 126), a stove 128, a plurality of faucets (faucet 1 130, . . . , faucet Q 131), a refrigerator 132, and additional monitored elements (additional monitored element 1 134, . . . , additional monitored element M 136), an alarm 138, e.g., an alarm siren and/or alarm light such as a xenon strobe (Reference ADA HANDBOOK Appendix B—4.28.3(1)), and one or more persons (person 1 140, . . . , person P 142), e.g. individuals residing at customer premises 1. The cameras (124, . . . , 126) are situated throughout customer premises 1 116 to be able to view one or more of objects of interest. For example, a first camera may be mounted to include the knobs on the stove within its field of view. A second camera may be mounted to include the handle of a faucet within its field of view. A third camera may be mounted to include a refrigerator door within its field of view. A fourth camera may be situated to view a hallway area in which a person frequency traverses. A fifth camera may be situated to view the bottom a stairway.

In some embodiments, one or more of the stove 128, faucet 130, . . . , faucet 131, refrigerator 132, additional monitored element 134, . . . , additional monitored element 136, are smart devices and are coupled to the access point 122 via a wireless and/or wired communications link, e.g., allowing the smart device to receive control commands from a monitoring system and take an action, e.g., shut off a gas or water valve or switch off electrical power or close a door.

Access point 122 includes a processor 170, e.g., a CPU, memory 172 including an assembly of software components 182 and data/information, a network interface 144, a wireless interface 174 including a wireless transmitter and a wireless receiver coupled to an antenna, a wired interface 176 including a receiver and a transmitter, an assembly of hardware components 180, e.g., an assembly of circuits, and a speaker 184, coupled together via bus 178 over which the various elements may interchange data and information. Access point 122 is coupled to the camera (124, . . . , 126), e.g., via wireless communications links. Access point 122 is coupled to the alarm, e.g., an alarm siren and/or an alarm light such as xenon strobe light, via, e.g., a wired communications link. In some embodiments, the alarm 138 outputs different types of alarms e.g., a different siren noise, a different color flashing light, a different strobe flash pattern, and/or a different broadcast message, corresponding to a different detected problem. Network interface 144 couples the access point 122 to the communications network 114, via network link 148. The access point of CP N 118 is coupled to communications network 114 via network link 160. Firehouse system 104, e.g., a system responsive to reported detected fires, detected smoke conditions, and detected carbon monoxide conditions, is coupled to communications network 114 via link 152. Police dispatcher system 106, e.g., a 911 dispatcher system, is responsive to many types of emergency conditions including reported heath, safety and medical emergency conditions, is coupled to communications network 114 via link 154. Other device or system 1 108 is coupled to communications network 114 via link 156, e.g., a cellular wireless link. Other device or system n 110 is coupled to communications network 114 via link 158, e.g., a cellular wireless link. In some embodiments, communication to the Firehouse system 104 and/or to the Police Dispatcher system 106 is, a via network link or any one of following: i) a Remote Supervising System, e.g., a system at a location including operators which monitor receiving equipment for incoming emergency signals, ii) a Certified Central Station, e.g., a central station including monitoring facilities compliant with UL published criteria, or iii) a Public Safety Answering Point (PSAP), e.g., a call center responsible for answering calls to an emergency telephone number.

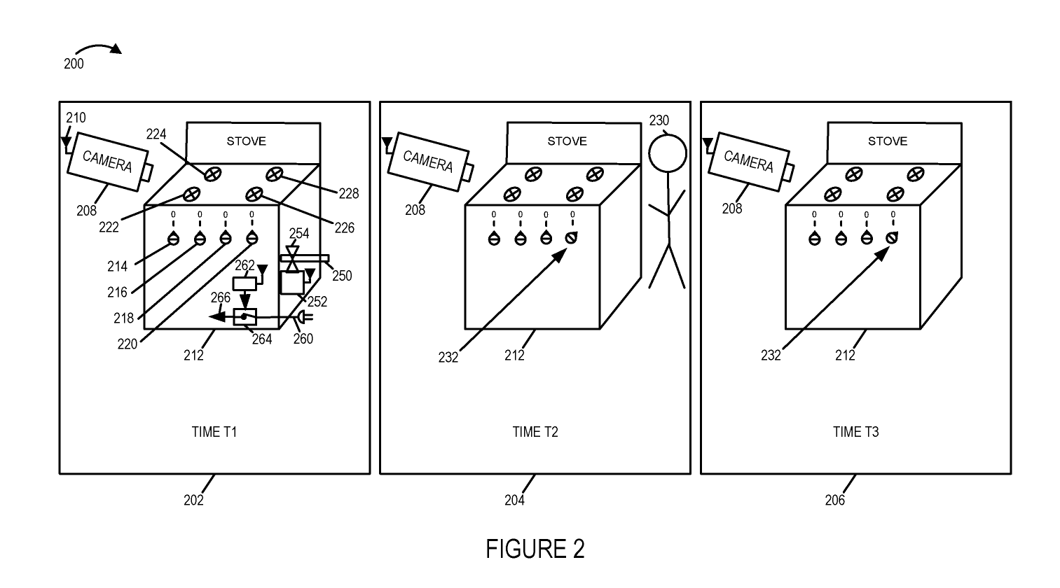

FIG. 2 is a drawing 200 including a monitored area of a customer premises site at exemplary various times in accordance with an exemplary embodiment. The monitored area shown in FIG. 2 includes a stove 212 and kitchen room area. The monitored area of FIG. 2 is being monitored via camera 208. Camera 208 includes antenna 210 via which the camera may send and receive signals, e.g., send captured images and receive command signals, to an access point at the customer premises site.

Stove 212 includes four stovetop burners (first burner 222, second burner 224, third burner 226 and fourth burner 228), and four burner control knobs (burner control knob 1 214, burner control knob 2 216, burner control knob 3 218, burner control knob 4 220), respectively, for independently controlling the burners. In some embodiments, stove 212 is a smart device and stove 212 includes a remotely controllable shutoff valve 254 coupled to a valve control circuit 252 which can be commanded, e.g., via a command sent from a monitoring system, to shut off gas flow through input pipe 250. In some embodiments, the building including stove 212 includes a remotely controllable main gas feed shutoff valve 254 coupled to a valve control circuit 252 which can be commanded, e.g., via a command sent from a monitoring system, to shut off gas flow through an input pipe 250. In some embodiments, the stove 212 is an electric range including a remotely controllable electric cutoff switch 264 and a control circuit 262. For example, remotely controllable electric cutoff switch 264 is coupled to control circuit 262 which can be commanded, e.g., via a command sent from a monitoring system to open switch 264 and disconnection the AC input power line 260 from the main range feed power line 266. Alternatively, in some embodiment, power to the electric stove can be remotely controlled at a different point, e.g., at a remotely controllable circuit breaker box or power distribution box including a control circuit which can receive a power shutoff signal from the monitoring system. Monitoring camera 208 is mounted such that the burner control knobs (214, 216, 218, 220) are within the field of view of camera 208.

Block 202 includes a captured view corresponding to capture time T1; camera 208 or an identifier of camera 208, is also shown in block 202, e.g., superimposed on the captured image, to indicate that camera 208 is the camera capturing the monitored area. At time T1 each of the burner control knobs (214, 216, 218, 220) is shown in the off position, with each knob's pointer being directed up toward the 0. In some embodiments, some ranges have different positions for off. In some embodiments, the off position is different for different control knobs on the same stove. In some embodiments, as part of a video training process for the monitoring system, e.g., part of a calibration process for the monitoring system, off is confirmed, e.g., for each control knob to be monitored, by a human input, e.g., with an off knob position confirmation being received by the monitoring system, so that the logic to be used in subsequent automated monitoring, will have and retain the correct knob position corresponding to off.

Block 204 includes a captured view corresponding to capture time T2; camera 208 or an identifier of camera 208, is also shown in block 204, e.g., superimposed on the captured image, to indicate that camera 208 is the camera capturing the monitored area. At time T2 each of the burner control knobs (214, 216, 218) is shown in the off position, with each knob's pointer being directed up toward the 0. At time T2 control knob 220 is shown in the ON position, e.g., the knob has been rotated clockwise from the OFF position, e.g., by approximately 45 degrees, and the knob pointer is no longer pointing up. Arrow 232 point to know 220 in the ON position. Thus at time T2, burner 4 228, which corresponds to knob 220, is lit. In various embodiments, the ON position is any position of the knob, in which the knob pointer is anywhere is predefined non-vertical up range of the pointer, e.g., the range of +5 degrees clockwise rotation to +355 degrees clockwise rotation corresponds to ON. In the captured image of block 204, person 230 is also visible, e.g., person 230 has lit burner 4 228 of the stovetop, and is still in the vicinity of the stove.

Block 206 includes a captured view corresponding to capture time T3; camera 208 or an identifier of camera 208, is also shown in block 206, e.g., superimposed on the captured image, to indicate that camera 208 is the camera capturing the monitored area. At time T3 each of the burner control knobs (214, 216, 218) is shown in the off position, with each knob's pointer being directed up toward the 0. At time T3 control knob 220 is still shown in the ON position indicating that burner 4 is still ON; however, at time T3 there is no person shown in the captured image indicating that the stove has been left unattended in an ON state.

In some embodiments, a timer is started at time T3, when the identified monitored knob is determined to be in an ON condition and a person is not detected to be present. In some such embodiments, after the timer reaches a predetermined value, at least one of: an action is taken to alter the condition, e.g., burner 4 228 is automatically turned off via a control signal sent to a gas control valve of the stove 212, or an alert is issued. In some embodiments, the alert includes one or more stages, e.g., a first stage alert including a local alarm, and a second stage alert to an emergency responder and/or a designated contact, e.g., if the detected condition is not resolved after the first stage alert.

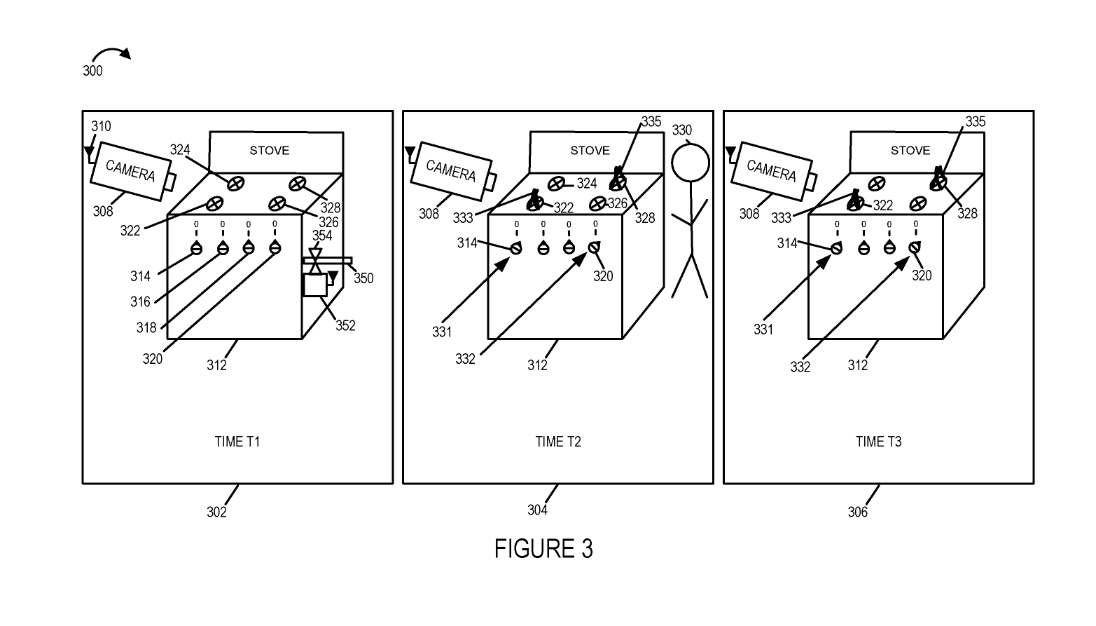

FIG. 3 is a drawing 300 including a monitored area of a customer premises site at exemplary various times in accordance with an exemplary embodiment. The monitored area shown in FIG. 3 includes a stove 312 and kitchen room area. The monitored area of FIG. 3 is being monitored via camera 308. Camera 308 includes antenna 310 via which the camera may send and receive signals, e.g., send captured images and receive command signals, to an access point at the customer premises site.

Stove 312 includes four stovetop burners (first burner 322, second burner 324, third burner 326 and fourth burner 328), and four burner control knobs (burner control knob 1 314, burner control knob 2 316, burner control knob 3 318, burner control knob 4 320), respectively, for independently controlling the burners. In some embodiments, stove 312 is a smart device and stove 312 includes a remotely controllable shutoff valve 354 coupled to a valve control circuit 352 which can be commanded, e.g., via a command sent from a monitoring system, to shut off gas flow through input pipe 350. In some embodiments, the building including stove 312 includes a remotely controllable main gas feed shutoff valve 354 coupled to a valve control circuit 352 which can be commanded, e.g., via a command sent from a monitoring system, to shut off gas flow through an input pipe 350. Monitoring camera 308 is mounted such that the burner control knobs (314, 316, 318, 320) and the burners (322, 324, 326, 328) are within the field of view of camera 308.

Block 302 includes a captured view corresponding to capture time T1; camera 308 or an identifier of camera 308, is also shown in block 302, e.g., superimposed on the captured image, to indicate that camera 308 is the camera capturing the monitored area. At time T1 each of the burner control knobs (314, 316, 318, 320) is shown in the off position, with each knob's pointer being directed up toward the 0. At time T1, no flames are visible at each of the burners (322, 324, 326, 328) indicating that each of the burners are not lit.

Block 304 includes a captured view corresponding to capture time T2; camera 308 or an identifier of camera 308, is also shown in block 304, e.g., superimposed on the captured image, to indicate that camera 308 is the camera capturing the monitored area. At time T2 each of the burner control knobs (316, 318) is shown in the off position, with each knob's pointer being directed up toward the 0. At time T2 control knobs (314, 220) is shown in the ON position, e.g., each knob (314, 320) has been rotated clockwise from the OFF position, e.g., by approximately 45 degrees, and the knob pointers of knobs (314, 320) are no longer pointing up.

Arrow 331 points to knob 314 in the ON position. Thus at time T2, burner 1 322, which corresponds to knob 314, is lit. At time T2, flame 333 is visible at burner 322.

Arrow 332 points to knob 320 in the ON position. Thus at time T2, burner 4 328, which corresponds to knob 320, is lit. At time T2, flame 335 is visible on burner 328.

In various embodiments, the ON position is any position of the knob, in which the knob pointer is anywhere is predefined non-vertical up range of the pointer, e.g., the range of +2 degrees clockwise rotation to +270 degrees clockwise rotation corresponds to ON.

In the captured image of block 304, person 330 is also visible, e.g., person 330 has lit burner 1 322 and burner 4 328 of the stovetop, and is still in the vicinity of the stove.

Block 306 includes a captured view corresponding to capture time T3; camera 308 or an identifier of camera 308, is also shown in block 306, e.g., superimposed on the captured image, to indicate that camera 308 is the camera capturing the monitored area. At time T3 each of the burner control knobs (316, 318) is shown in the off position, with each knob's pointer being directed up toward the 0 and no flames are visible at burners (burner 2 324, burner 3 326). At time T3: i) control knob 314 is still shown in the ON position and flame 333 is visible at burner 1 322 both indicating that burner 1 322 is still ON; ii) control knob 320 is still shown in the ON position and flame 335 is visible at burner 4 328 both indicating that burner 4 is still ON; however, at time T3 there is no person shown in the captured image indicating that the stove has been left unattended with one or more burners in an ON state.

In some embodiments, a timer is started at time T3, when at least one identified monitored knob is determined to be in an ON condition or at least one flame is detected at a burner and a person is not detected to be present. In some such embodiments, after the timer reaches a predetermined value, at least one of: an action is taken to alter the condition, e.g., burner 1 322 and burner 4 328 is automatically turned off via a control signal sent to one or two gas control valves of the stove 312, or an alert is issued. In some embodiments, the alert includes one or more stages, e.g., a first stage alert including a local alarm, and a second stage alert to an emergency responder and/or a designated contact, e.g., if the detected condition is not resolved after the first stage alert.

In some embodiments, the identified position of a burner knob in the ON positions and the identified lack of presence of a flame on a corresponding burner is further used to identify an unlit burner condition and the potential of unburned gas being vented and to respond to the identified unlit burner condition.

In some embodiments, in which the stove, e.g., stove 212 or 312, includes an electric range, the color of each of the electric burner range elements (222, 224, 226, 228) or (322, 324, 326, 328) is identified from the captured images, and the on or off status of each electric burners is determined based on the identified color.

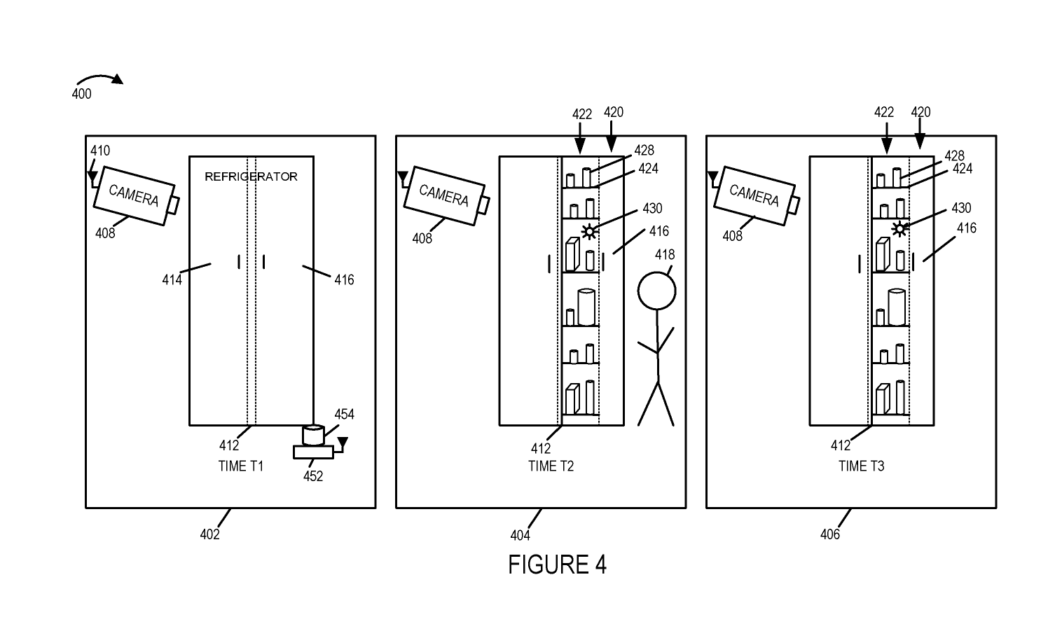

FIG. 4 is a drawing 400 including a monitored area of a customer premises site at exemplary various times in accordance with an exemplary embodiment. The monitored area shown in FIG. 4 includes a refrigerator 412 and kitchen room area. The monitored area of FIG. 4 is being monitored via camera 408. Camera 408 includes antenna 410 via which the camera 408 may send and receive signals, e.g., send captured images and receive command signals, to an access point at the customer premises site.

Refrigerator 412 includes refrigerators doors 414 and 416. In some embodiments, the refrigerator 412 is a smart device and refrigerator 412 includes a refrigerator door motor 454 which can be controlled via control circuit 452 to close a detected open door in response to a signal sent from a monitoring system. Monitoring camera 408 is mounted such that the refrigerator doors (414, 416) are within the field of view of camera 408.

Block 402 includes a captured view corresponding to capture time T1; camera 408 or an identifier of camera 408, is also shown in block 402, e.g., superimposed on the captured image, to indicate that camera 408 is the camera capturing the monitored area. At time T1 each of the refrigerator doors (414, 416) is shown in the closed position.

Block 404 includes a captured view corresponding to capture time T2; camera 408 or an identifier of camera 408, is also shown in block 404, e.g., superimposed on the captured image, to indicate that camera 408 is the camera capturing the monitored area. At time T2 refrigerator door 414 is shown in the closed position. At time T2 refrigerator door 416 is shown in open position, as pointed to by arrow 420. Internal shelves 424 and food cartons, packages, or items 428 are visible, as pointed to by arrow 422. In addition internal refrigerator light 430 is visible. In the captured image of block 404, person 418 is also visible, e.g., person 418 has opened refrigerator door 416, e.g., to get some food out of the refrigerator or put some food in the refrigerator and person 418 is still in the vicinity of the refrigerator.

Block 406 includes a captured view corresponding to capture time T3; camera 408 or an identifier of camera 408, is also shown in block 406, e.g., superimposed on the captured image, to indicate that camera 408 is the camera capturing the monitored area. At time T3 refrigerator door 416 is still shown in open position, the internal shelves 424 and food cartons, packages, or items 428 are still visible, and the internal refrigerator light 430 is still visible; however, at time T3 there is no person shown in the captured image indicating that the refrigerator has been left unattended in a state with an open door, e.g., person 418 has forgot about the open door on the refrigerator and has went away and left the room.

In some embodiments, a timer is started at time T3, when there is an identified open refrigerator door and a person is not detected to be present. In some such embodiments, after the timer reaches a predetermined value, at least one of: an action is taken to alter the condition, e.g., refrigerator door 416 is automatically closed via a control signal sent to a control circuit controlling a refrigerator door motor of the refrigerator 412, or an alert is issued. In some embodiments, the alert includes one or more stages, e.g., a first stage alert including a local alarm, and a second stage alert to a designated contact, e.g., if the detected condition is not resolved after the first stage alert.

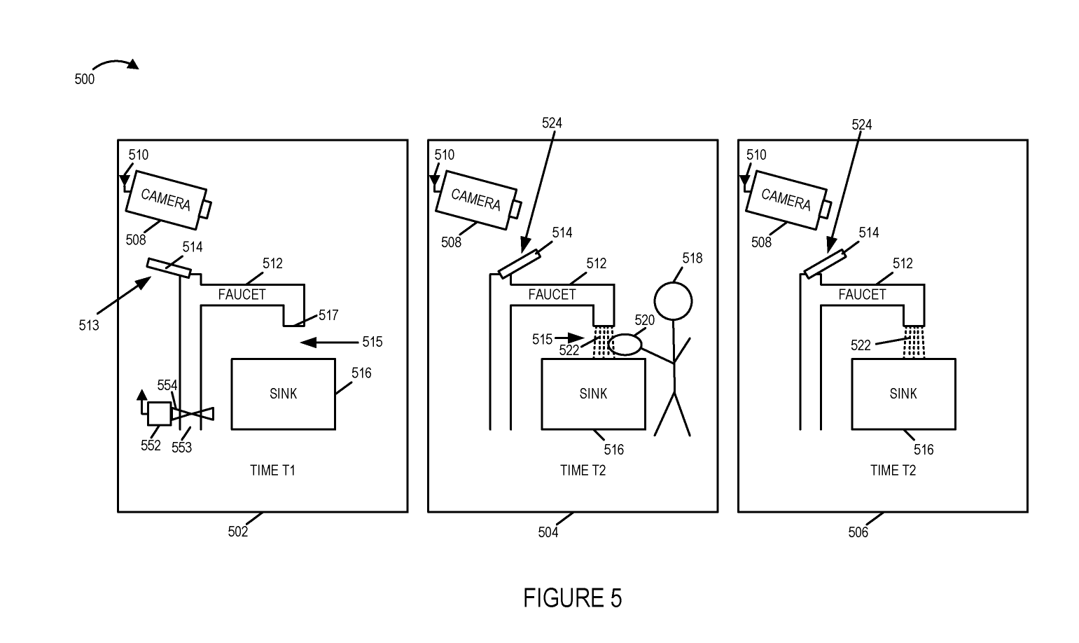

FIG. 5 is a drawing 500 including a monitored area including of a customer premises site at exemplary various times in accordance with an exemplary embodiment. The monitored area shown in FIG. 5 includes a faucet 512, a sink 516 and kitchen room area in which the faucet 512 is located. The monitored area of FIG. 5 is being monitored via camera 508. Camera 508 includes antenna 510 via which the camera 508 may send and receive signals, e.g., send captured images and receive command signals, to an access point at the customer premises site.

Faucet 512 includes faucet handle 514. Monitoring camera 508 is mounted such that the faucet handle 514 and the area 515 between the faucet 512 and the sink 516 are within the field of view of camera 508. In some embodiments, the faucet 512 includes a remotely controllable shutoff valve 554 coupled to a valve control circuit 552 which can be commanded, e.g., via a command sent from a monitoring system, to shut off water flow through input pipe 553. In some embodiments, the building including the faucet 512 includes a remotely controllable main water feed shutoff valve 554 coupled to a valve control circuit 552 which can be commanded, e.g., via a command sent from a monitoring system, to shut water flow through an input pipe.

Block 502 includes a captured view corresponding to capture time T1; camera 508 or an identifier of camera 508, is also shown in block 502, e.g., superimposed on the captured image, to indicate that camera 508 is the camera capturing the monitored area. At time T1 faucet handle 514 is shown in the closed, e.g., no water flow position. Arrow 513 points to faucet handle 514 in the closed position. At time T1, no water is shown to be flowing in area 515 between the water output 517 of faucet 512 and the sink 516.

Block 504 includes a captured view corresponding to capture time T2; camera 508 or an identifier of camera 508, is also shown in block 504, e.g., superimposed on the captured image, to indicate that camera 508 is the camera capturing the monitored area. At time T2 faucet handle 514 is shown in open position, e.g., water flow position, as pointed to by arrow 524. At time T2 a stream of water 522 is also observed to be flowing through area 515. In the captured image of block 504, person 518 is also visible, e.g., person 518 has turned on the water to wash dishes 520.

Block 506 includes a captured view corresponding to capture time T3; camera 508 or an identifier of camera 508, is also shown in block 506, e.g., superimposed on the captured image, to indicate that camera 508 is the camera capturing the monitored area. At time T3 faucet handle 514 is still shown in open position, e.g., water flowing position, and water stream 522 is still visible; however, at time T3 there is no person shown in the captured image indicating that the sink 516 has been left unattended with the water running, e.g., person 518 has forgotten to turn off the water after finishing washing the dishes and has went away and left the room.

In some embodiments, a timer is started at time T3, when there is an identified faucet with a faucet handle is the open position and a person is not detected to be present. In some such embodiments, after the timer reaches a predetermined value, at least one of: an action is taken to alter the condition, e.g., the water is automatically closed via a control signal sent to a control circuit controlling a water control valve for the faucet 512, or an alert is issued. In some embodiments, the alert includes one or more stages, e.g., a first stage alert including a local alarm, and a second stage alert to a designated contact, e.g., if the detected condition is not resolved after the first stage alert.

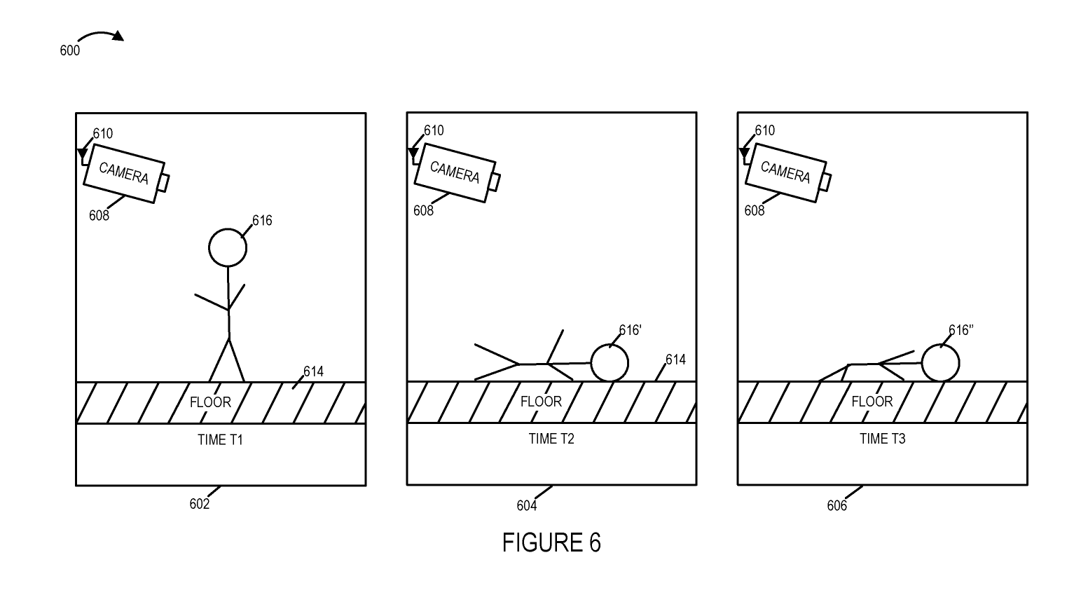

FIG. 6 is a drawing 600 including a monitored area of a customer premises site at exemplary various times in accordance with an exemplary embodiment. The monitored area, e.g., a base of staircase, a hallway, an open area with no railings, an area including an interface between the edge of a rug and a wooden floor, or and area with obstructions in which a person may be likely to fall, shown in FIG. 6 includes a floor 614. The monitored area of FIG. 6 is being monitored via camera 608. Camera 608 includes antenna 610 via which the camera 608 may send and receive signals, e.g., send captured images and receive command signals, to an access point at the customer premises site.

Block 602 includes a captured view corresponding to capture time T1; camera 608 or an identifier of camera 608, is also shown in block 602, e.g., superimposed on the captured image, to indicate that camera 608 is the camera capturing the monitored area. At time T1, person 616 is observed to be standing vertical with respect to floor 614.

Block 604 includes a captured view corresponding to capture time T2; camera 608 or an identifier of camera 608, is also shown in block 604, e.g., superimposed on the captured image, to indicate that camera 608 is the camera capturing the monitored area. At time T2, person 616, as represented by 616′ is observed to be lying on the floor 614, e.g., lying on the ground.

Block 606 includes a captured view corresponding to capture time T3; camera 608 or an identifier of camera 608, is also shown in block 606, e.g., superimposed on the captured image, to indicate that camera 608 is the camera capturing the monitored area. At time T2, person 616, as represented by 616″, is observed to be still lying on the floor 614, e.g., lying on the ground.

In some embodiments, a timer is started at time T2, when there is an identified person lying on the ground. In some such embodiments, after the timer reaches a predetermined value and time T3 has been reached, if the person is still detected to be lying on the ground an alert is issued. In some embodiments, the alert includes one or more stages, e.g., a first stage alert including a local alarm, and a second stage alert to a emergency responder and/or a designated contact, e.g., if the person lying on the ground does not get up after the first stage alert. If the person detected to be on the ground is on the ground for another reason, e.g., cleaning or searching for a dropped item, the local alert is useful to avoid unnecessary sending of an emergency responder for a false alarm.

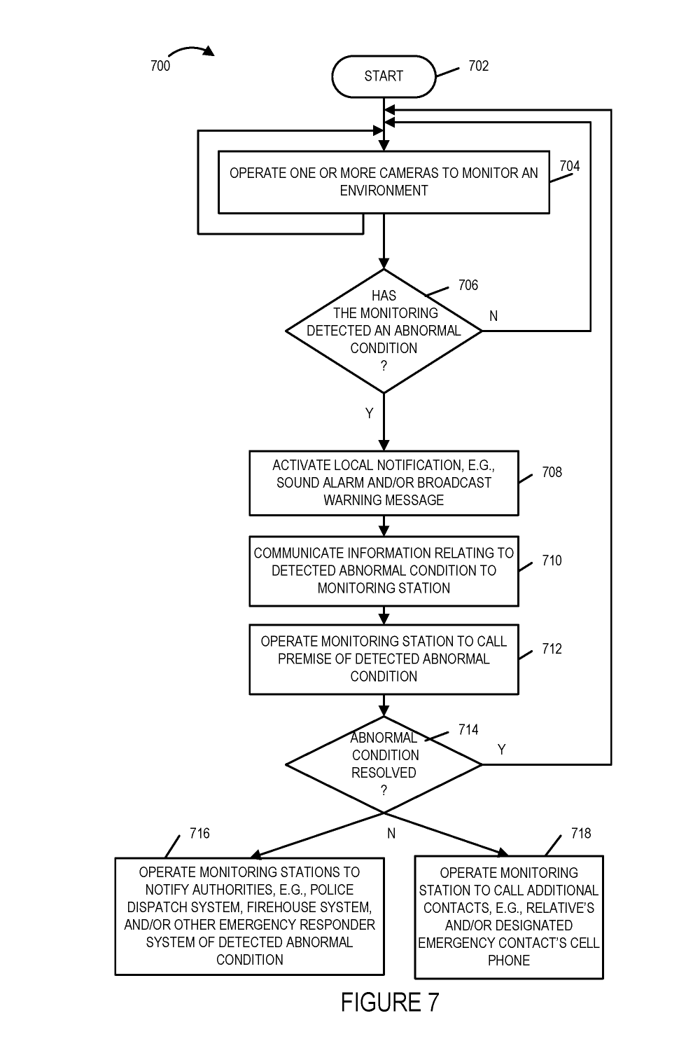

FIG. 7 is a flowchart 700 of an exemplary method of operating a monitoring system to monitor for and detect abnormal conditions in a monitored environment, e.g., an elderly person's home including camera and identified objected of interest, and to respond to detected abnormal conditions in accordance with an exemplary embodiment. Operation of the exemplary method starts in step 702 in which the monitoring system is powered on and initialized. Operation proceeds from step 702 to step 704. In step 704 one or more cameras are operated to monitor an environment, e.g. on an ongoing and/or recurring basis. The monitored environment includes, e.g., a stove and area in the vicinity of the stove, a refrigerator and area in the vicinity of the refrigerator, a sink and area in the vicinity of the sink, and one or more locations in which a person may be likely to slip and fall, e.g., the base of a stairway, an obstructed area, an area with an uneven floor, etc. Operation proceeds from step 704 to step 706.

In step 706 the monitoring system determines if the monitoring has detected an abnormal condition. Exemplary abnormal conditions include: i) detecting a stovetop burner in an on state, e.g., via knob position and/or flame detection, for a predetermined length of time with no one present in the area; ii) detecting a faucet running, e.g., via faucet handle position and/or water flow detection, for a predetermined length of time with no one present in the area, iii) detecting a refrigerator door being open, e.g., via door position, interior of refrigerator showing, and/or via refrigerator interior light showing, for a predetermined length of time with no one present in the area; or iv) detecting a person remaining on the ground for a predetermined length of time.

If the monitoring has not detected an abnormal condition, then operation proceeds from step 706 to the input of step 704, for additional monitoring. However, if the monitoring has detected an abnormal condition, then operation proceeds from step 706 to step 708.

In step 708 a local notification is activated, e.g., an alarm is sounded, a xenon Americans with Disabilities (ADA) compliant strobe light is activated, and/or a warning message is broadcasted at the monitored site. Operation proceeds from step 708 to step 710. In some embodiments, operation proceeds to step 710 if the detected anomaly is not corrected after a predetermined amount of time following the local notification.

In step 710 information relating to the detected abnormal condition is communicated to a monitoring station, e.g., the access point at the customer premises site sends a message to a monitoring station, e.g., at a network head end site, informing the monitoring station of the unresolved detected abnormal condition. Operation proceeds from step 710 to step 712.

In step 712 the monitoring station is operated to call the premises of the detected abnormal condition. Operation proceeds from step 712 to step 714. In step 714 if the abnormal condition is resolved, then the anomaly indication is cleared and operation proceeds from step 714 top step 704 for additional monitoring. However, if the abnormal condition is not resolved in response to the call to the monitored site, then operation proceeds from step 714 to one or both of steps 716 and 718. In step 716 the monitoring station is operated to notify authorities, e.g., a police dispatch system, a firehouse system, and/or an other emergency responder system of the detected abnormal condition. In step 718 the monitoring station is operated to call additional contacts, e.g., relatives and/or designated emergency contact's cell phones to report the detected abnormal condition at the monitored site.

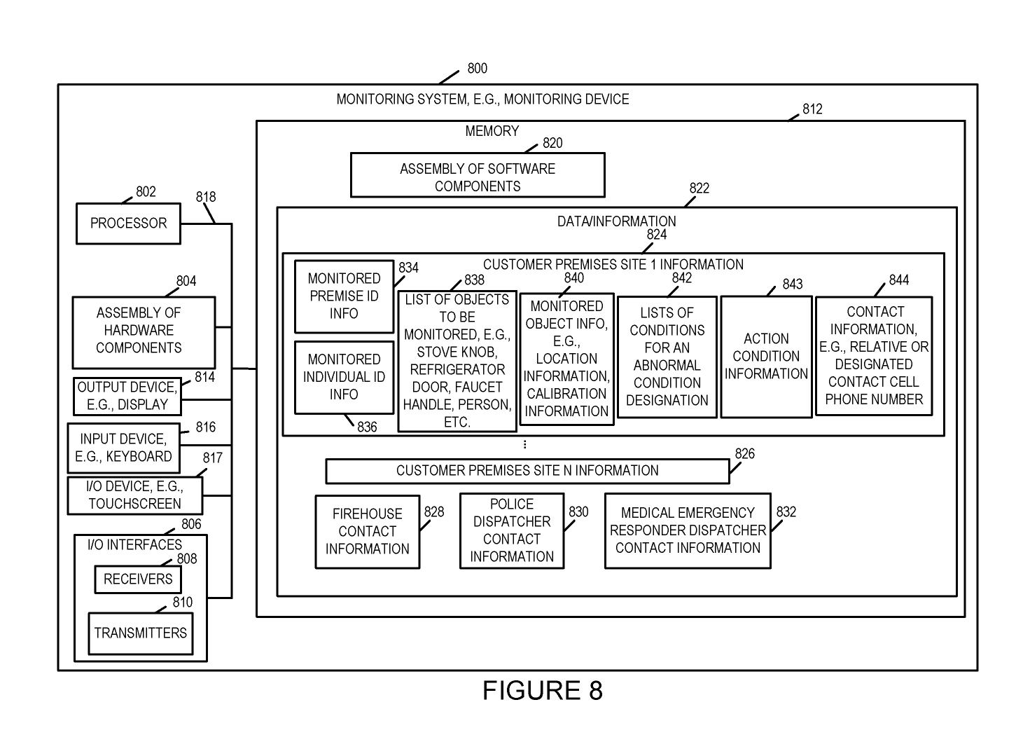

FIG. 8 is a drawing of an exemplary monitory system, e.g., a monitoring device, in accordance with an exemplary embodiment. Exemplary monitoring system 800 is, e.g., exemplary monitoring system 120 of FIG. 1. Exemplary monitoring system 800 includes a processor 802, e.g., a CPU, an assembly of hardware components, 804, e.g., an assembly of circuits, an output device 814, e.g., a display, an input device 816, e.g., a keyboard, an I/O device 817, e.g., a touch screen display, I/O interfaces 806, and memory 812 coupled together via a bus 818 over which the various components may exchange data and information. I/O interfaces 806 includes receivers 808, e.g., wired and/or wireless receivers, and transmitters 810, e.g., wired and/or wireless transmitters, via which the monitoring system may receive and send data and information. Memory 812 includes an assembly of software components 820, e.g., routines, and data/information 822. In one exemplary embodiment assembly of software components includes a main monitoring, detection, determination and action routine, a door action conditions satisfaction subroutine, a knob action satisfaction determination subroutine, a faucet handle conditions satisfaction determination subroutine and a person action conditions satisfaction subroutine. In one exemplary embodiment assembly of hardware components 804 implements the main monitoring, detection, determination and action routine, a door action conditions satisfaction subroutine, a knob action satisfaction determination subroutine, a faucet handle conditions satisfaction determination subroutine and a person action conditions satisfaction subroutine.

Data information 822 includes sets of information corresponding to a plurality of customer premises sites which are being monitored using camera located at the customer premises site (customer premises site 1 information 824, . . . , customer premises site N information 826), firehouse contact information 828, e.g., a phone numbers and/or email addresses corresponding to firehouses which serve the customer premises sites being monitored, police dispatcher contact information 830, e.g., phone numbers and/or email addresses corresponding to 911 centers or police stations corresponding to the customer premises sites being monitored, and medical emergency responder dispatcher contact information 832, e.g., phone numbers and/or email addresses corresponding to emergency medical services, ambulances, and/or hospitals corresponding to the customer premises sites being monitored.

Customer premises site 1 information 824 includes monitored premises ID information 834, e.g., information identifying customer premises site 1 including location information, monitored individual ID information 836, e.g., information identifying a person of interest at customer premises 1 which is being monitored, list of objects to be monitored 838, e.g., a stove knob, a refrigerator door, a faucet handle, a person, etc. In some embodiments, monitored individual ID information includes a name of a monitored individual, a monitoring system assigned ID number corresponding to the monitored individual, a health plan number of the monitored individual and the cell phone number of the monitored individual's cell phone. In some embodiments, the person of interest is a person residing at the customer premise site. In some embodiments, the identified person of interest is an elderly or disabled person residing at customer premises 1. In some embodiments, there may be, and sometimes are, multiple persons of interest residing at customer premise 1. In some such embodiments, the monitoring system includes different information corresponding to the different monitored individuals, e.g., different emergency contact information and/or different emergency medical instructions information corresponding to the different individuals. In some embodiments, the monitoring system includes individual recognition capabilities, e.g., face and/or other physical characteristic recognition capability, e.g., for identifying a monitored individual who has been detected on the ground. Customer premises site 1 information 840 further includes monitored object information, e.g., location information within the site corresponding to each of the monitored objects, information specifying which camera at the site should capture the monitored object and information identifying a portion of a captured image from the designated camera in which the monitored objects should appear, calibration information, e.g., information identifying a first knob position corresponding to off and a second knob position corresponding to on, information identifying a first faucet handle position corresponding to open (on) and information identifying a second faucet handle position corresponding to closed (off), information identifying an expected image portion and/or expected pixels corresponding to a condition, e.g., presence of a flame at a burner or presence of water flowing from the end of the faucet, information used to detect the presence of a person, information used to detect whether a person is standing or lying on the ground, etc. Customer premises site 1 information 824 further includes lists of conditions for an abnormal condition designation 842, e.g., detected stove burner knob in the ON position and detected flame present with no detected person present in the vicinity of the stove for a predetermined length of time, refrigerator door detected to be open with no detected person in the vicinity for a predetermined length of time, detected faucet handle in the ON (open) position with detected water running from the faucet with no detected person in the vicinity for a predetermined length of time, detected person lying on the ground for a predetermined length of time.

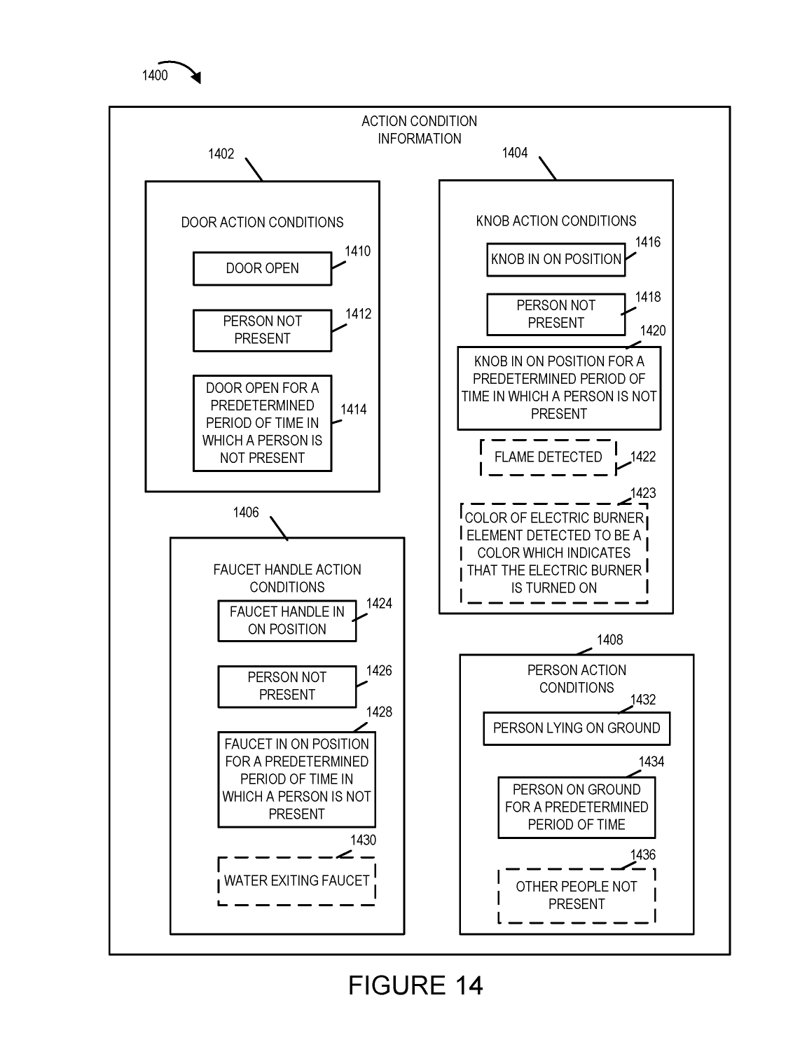

Customer premises site 1 information 824 further includes action condition information 843. Action condition information 843 includes sets of action conditions which are tested, e.g., as part of the customer premises site 1 monitoring, to see if a set of conditions are satisfied, e.g., by an action condition satisfaction determination routine being implemented for customer premises site 1. In one embodiment, action condition information 1400 of FIG. 14 is action condition information 843 of FIG. 8. Action condition information 1400 includes door action conditions 1402, knob action conditions 1404, faucet handle action conditions 1406, and person action conditions 1408. Door action conditions 1402, e.g., refrigerator door action conditions, includes door open 1410, person not present 1412 and door open for a predetermined period of time in which a person is not present 1414. In some embodiments, the door action conditions 1402 includes internal refrigerator light on detected. Knob action conditions 1404, e.g., stove burner knob action conditions, includes knob in ON position 1416, person not present 1418 and knob in ON position for a predetermined period of time in which a person is not present 1420. In some embodiments, knob action conditions 1404 includes flame detected 1422, e.g., flame detected at the burner corresponding to the knob. In some embodiments, knob action conditions 1404 includes a color of electric burner element detected to be a color which indicates that the burner corresponding to the knob is on 1423. Faucet handle action conditions 1406 includes faucet handle in ON position 1424, person not present 1426, faucet handle in ON position for a predetermined period of time in which a person is not present 1428 and, in some embodiments, water exiting the faucet 1430. Person action conditions 1408 includes person lying on the ground 1432, person on ground for a predetermined length of time 1434, and in some embodiments, other people not present 1436.

Customer premises site 1 information 824 further includes contact information 844, e.g., a relative's or designated contact's cell phone number, landline phone number and/or e-mail address to be notified in case of detected abnormal condition detected by the monitoring at customer premises site 1.

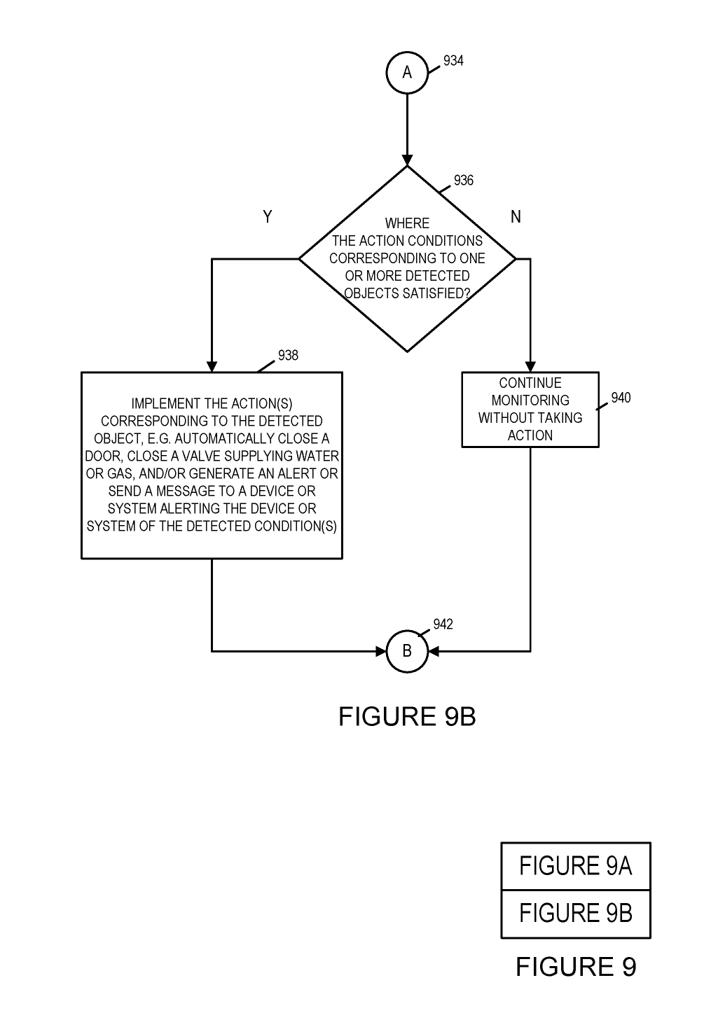

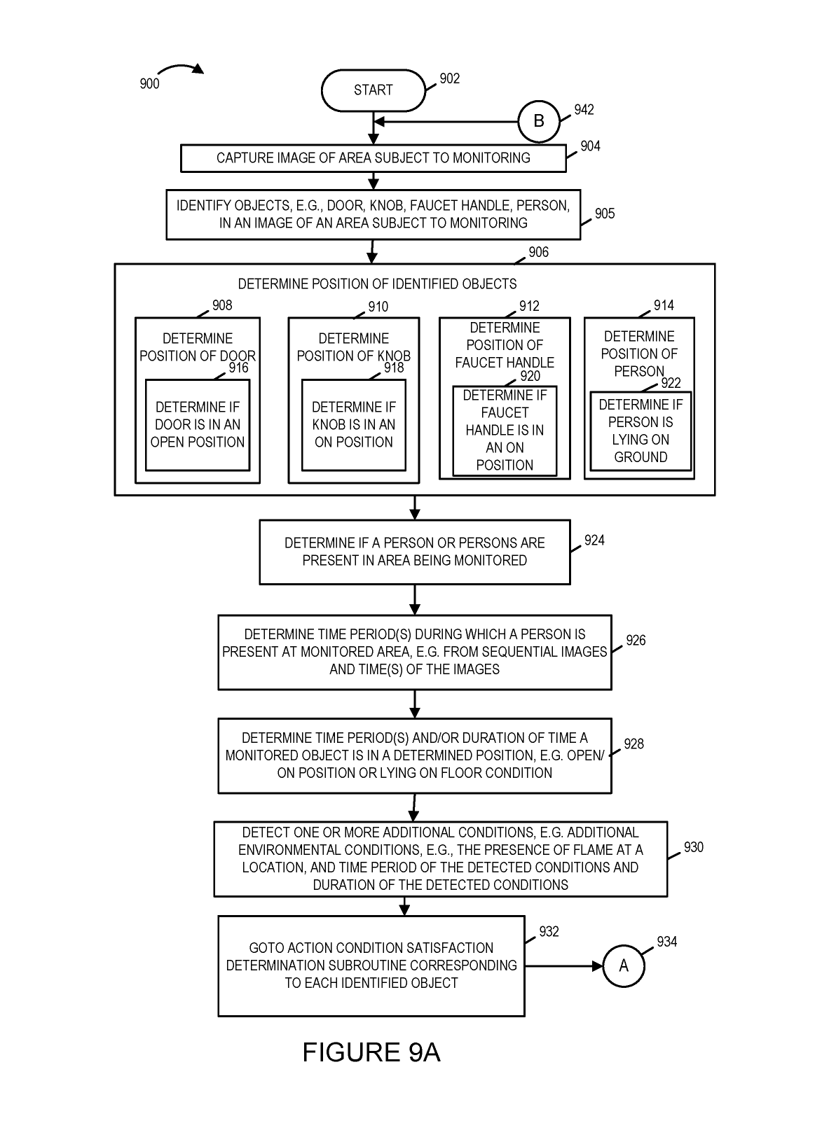

FIG. 9, comprising the combination of FIG. 9A and FIG. 9B, is a flowchart 900 of an exemplary method of detecting conditions, e.g., abnormal conditions, at a monitored site, and responding, in accordance with an exemplary embodiment. Operation of the exemplary method starts in step 902 in which the monitoring system is powered on and initialized. In step 904 an image of the area subject to monitoring is captured. In some embodiments, a plurality of cameras located at a customer premises site to capture images, e.g., at least some different cameras throughout the home having been mounted to capture different monitored areas including different objects of interest. In some embodiments, different monitored objects correspond to different rooms. In one exemplary embodiment, each of the monitored objects corresponds to the same room, e.g., the refrigerator door, kitchen faucet handle, and stove range top knob, are located in the kitchen room. Operation proceeds from step 904 to step 905.

In step 905, the monitoring system identifies objects, e.g., a door, a knob, a faucet handle, a person, etc., in an image of an area subject to monitoring. Operation proceeds from step 905 to step 906.

In step 906 the monitoring system determines the position of the identified objects. Step 906 includes steps 908, 910, 912 and 914. In step 908 the monitoring system determines the position of a door, e.g., a refrigerator door. In step 910 the monitoring system determines the position of a knob, e.g., a stovetop burner control knob. In step 912 the monitoring system determines the position of a faucet handle. In step 914 the monitoring system determines the position of a person. Step 908 includes step 916 in which the monitoring system determines if the door is in an open position. Step 910 includes step 918 in which the monitoring system determines if the knob is in an on position. In some embodiments, in step 910 determining the position of the knob includes determining the position of the knob to be one of an on position or an off position. Step 912 includes step 920 in which the monitoring system determines if the faucet handle is in an on position. In some embodiments, in step 912 determining the position of the faucet handle includes determining the position of the faucet handle to be one of an on position, e.g., a water flow position (water valve attaching to handle open position), or an off position, e.g., a no water flow position (water valve attaching to handle closed position). Step 914 includes step 922 in which the monitoring system determines if the person is lying on the ground, e.g., floor. In some embodiments, in step 914 determining the position of a person includes determining the position of the person to be one of lying on the ground or another position in the area subject to monitoring. Operation proceeds from step 906 to step 924.

In step 924 the monitoring system determines if a person or persons are present in area being monitored, e.g., is there a person in the vicinity of a refrigerator door being monitored, is there a person in the vicinity of a stove knob being monitored, is there a person in the vicinity of a water faucet handle being monitored. In some embodiments, being in the vicinity of a monitored object, means being in the same room as the object being monitored. Operation proceeds from step 924 to step 926.

In step 926 the monitoring system determines time period(s) during which a person is present at a monitored area, e.g., from sequential images and times of the images. Operation proceeds from step 926 to step 928.

In step 928 the monitoring system determines time period(s) and/or a duration of time a monitored object is in a determined position, e.g., open/ON position or lying on the floor. Operation proceeds from step 928 to step 930. In step 930 the monitoring system detects one or more additional conditions, e.g. additional environmental conditions, e.g., the presence of a flame at a burner location, presence of a visible refrigerator interior light, presence of water flowing from the faucet, etc., and time period of the detected conditions and duration of the detected conditions. Operation proceeds from step 930 to step 932.

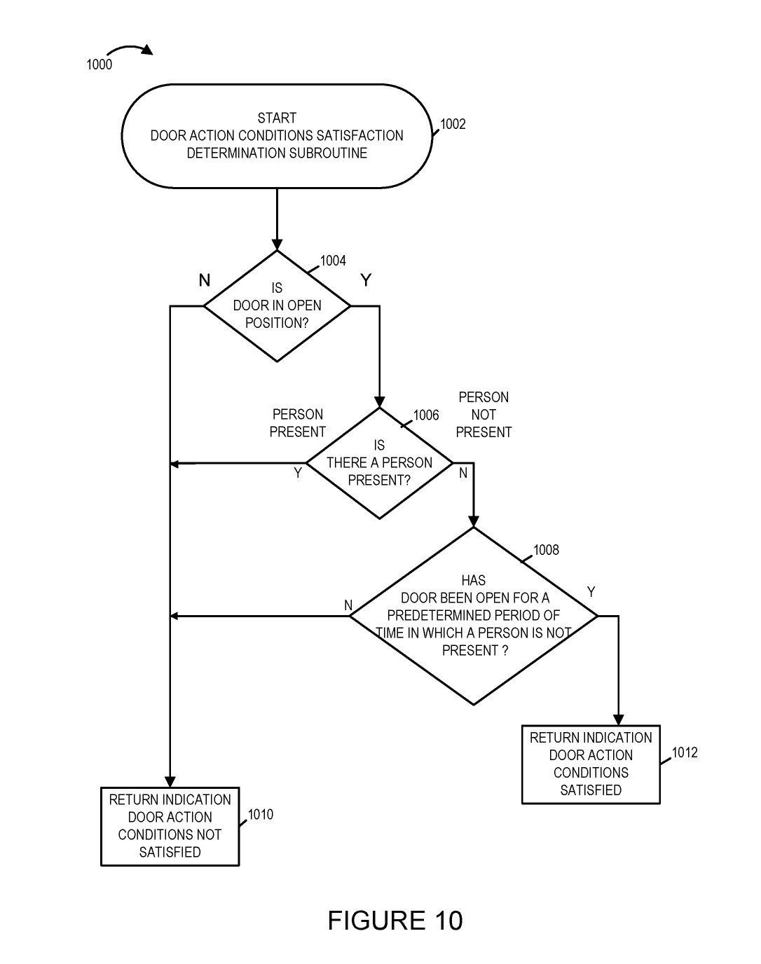

In step 932, operation proceeds to the action condition satisfaction determination subroutine corresponding to each identified object. When the identified object is a door, e.g., a refrigerator door, operation proceeds to door action condition satisfaction determination subroutine 1000 of FIG. 10. In step 1002 the door action condition satisfaction determination subroutine starts, and the determined and detected information, e.g., from steps 908, 916, 924, 926, 928, and 930, is input to the subroutine. Operation proceeds from start step 1002 to step 1004. In step 1004 if the door is in the open position, then operation proceeds from step 1004 to step 1006; otherwise, operation proceeds to step 1010. In step 1006, if there is a not a person present then operation proceeds to step 1008; otherwise, operation proceeds to step 1010. In step 1008 if the door has been open for a predetermined period of time in which a person is not present, then operation proceeds from step 1008 to step 1012; otherwise, operation proceeds to step 1010.

In step 1012, the door action conditions satisfaction determination subroutine returns an indication that the door action conditions are satisfied. Alternatively, in step 1010 the door action conditions satisfaction determination subroutine returns an indication that the door action conditions are not satisfied.

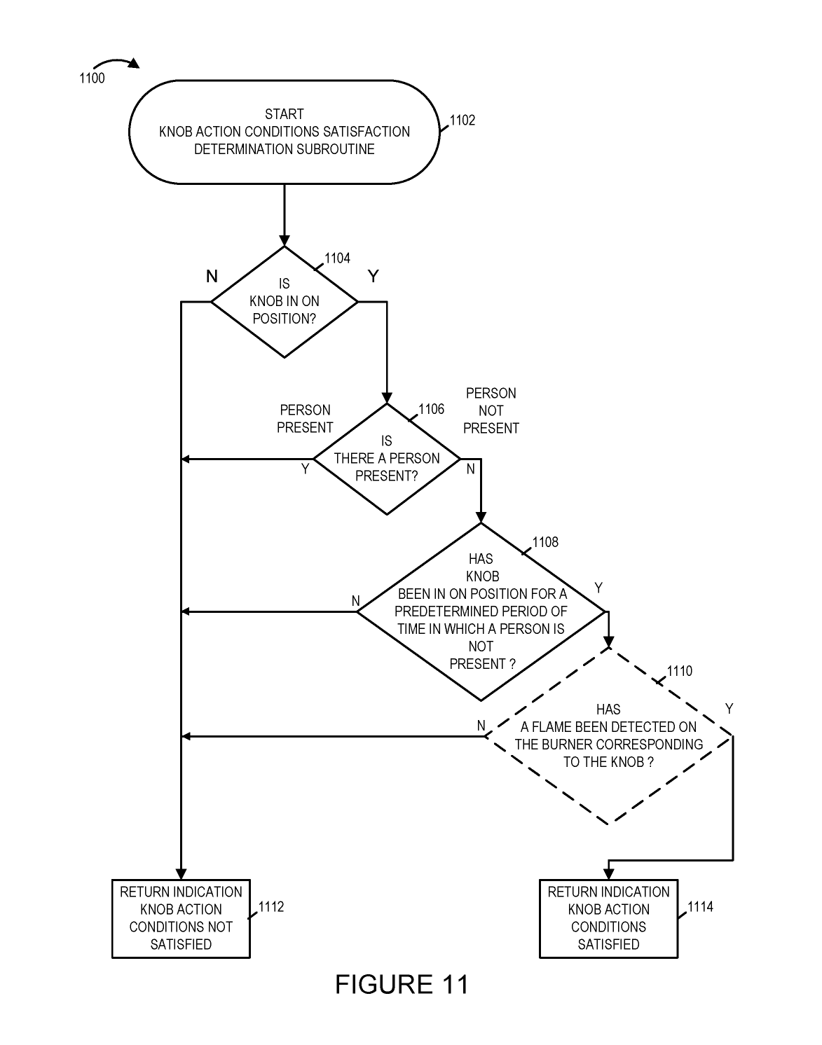

When the identified object is a knob, e.g., a stove burner control knob, operation proceeds to knob action condition satisfaction determination subroutine 1100 of FIG. 11. In step 1102 the knob action condition satisfaction determination subroutine starts, and the determined and detected information, e.g., from steps 910, 918, 924, 926, 928, and 930, is input to the subroutine. Operation proceeds from start step 1102 to step 1104. In step 1104 if the knob is in the ON position, then operation proceeds from step 1104 to step 1106; otherwise, operation proceeds to step 1112. In step 1106, if there is a not a person present then operation proceeds to step 1108; otherwise, operation proceeds to step 1112. In step 1108 if the knob has been in an ON position for a predetermined period of time in which a person is not present, then operation proceeds from step 1108 to step 1114 or to optional step 1110; otherwise, operation proceeds to step 1112. In step 1110 if a flame has been detected on the burner corresponding to the knob, then operation proceeds to step 1114; otherwise operation proceeds to step 1112.

In step 1114, the knob action conditions satisfaction determination subroutine returns an indication that the knob action conditions are satisfied. Alternatively, in step 1112 the knob action conditions satisfaction determination subroutine returns an indication that the knob action conditions are not satisfied.

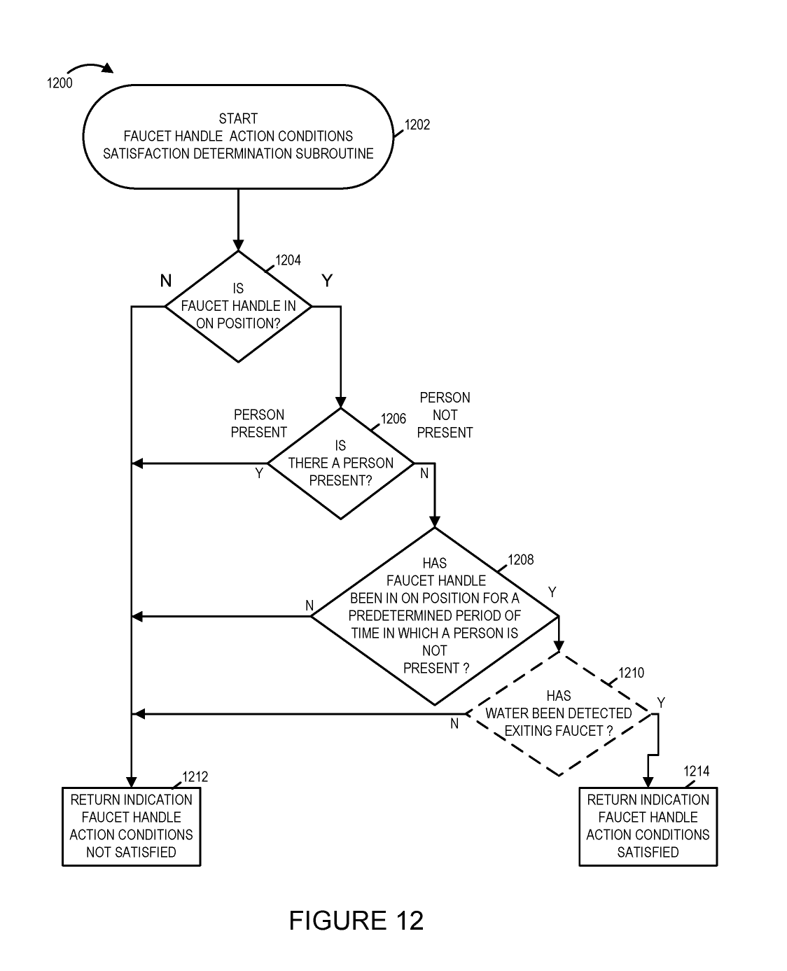

When the identified object is a faucet handle, operation proceeds to faucet handle action condition satisfaction determination subroutine 1200 of FIG. 12. In step 1202 the faucet handle action condition satisfaction determination subroutine starts, and the determined and detected information, e.g., from steps 912, 920, 924, 926, 928, and 930, is input to the subroutine. Operation proceeds from start step 1202 to step 1204. In step 1204 if the faucet handle is in the ON position, then operation proceeds from step 1204 to step 1206; otherwise, operation proceeds to step 1212. In step 1206, if there is a not a person present, e.g., in the vicinity of the faucet, then operation proceeds to step 1208; otherwise, operation proceeds to step 1212. In step 1208 if the faucet handle has been in an ON position for a predetermined period of time in which a person is not present, then operation proceeds from step 1208 to step 1214 or to optional step 1210; otherwise, operation proceeds to step 1212. In step 1210 if water has been detected exiting the faucet, then operation proceeds to step 1214; otherwise, operation proceeds to step 1212.

In step 1214, the faucet handle action conditions satisfaction determination subroutine returns an indication that the knob action conditions are satisfied. Alternatively, in step 1112 the knob action conditions satisfaction determination subroutine returns an indication that the knob action conditions are not satisfied.

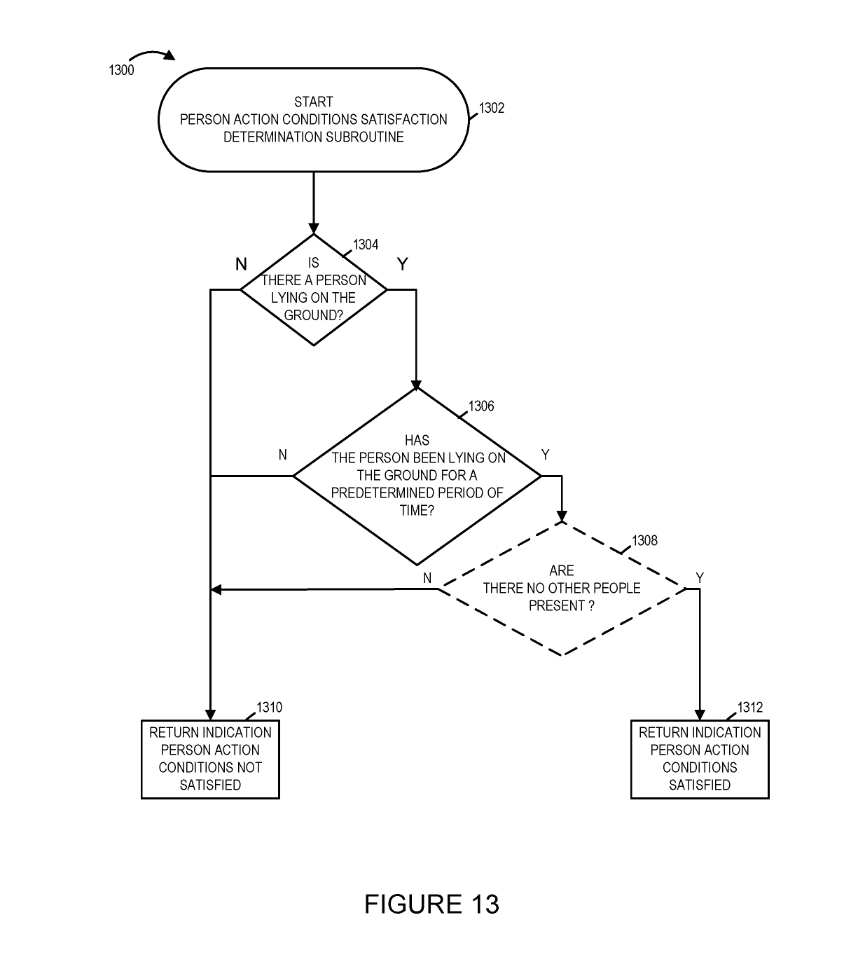

When the identified object is a person, operation proceeds to person action condition satisfaction determination subroutine 1300 of FIG. 13. In step 1302 the person action condition satisfaction determination subroutine starts, and the determined and detected information, e.g., from steps 914, 922, 924, 926, 928, and 930, is input to the subroutine. Operation proceeds from start step 1302 to step 1304. In step 1304 if there is a person lying on the ground, then operation proceeds from step 1304 to step 1306; otherwise, operation proceeds to step 1310. In step 1306, if the person has been lying on the ground for a predetermined period of time then operation proceeds from step 1306 to step 1312 or to optional step 1308; otherwise, operation proceeds to step 1310. In step 1308 if there are no other people present, then operation proceeds to step 1312; otherwise, operation proceeds to step 1310.

In step 1312, the person action conditions satisfaction determination subroutine returns an indication that the person action conditions are satisfied. Alternatively, in step 1310 the knob action conditions satisfaction determination subroutine returns an indication that the person action conditions are not satisfied.

Operation proceeds from step 932 via connecting node A 934 to step 936. In step 936 the monitoring system determines whether or not the action conditions corresponding to one or more detected objects were satisfied. If the determination is that the action conditions corresponding to one or more detected objects was satisfied, then operation proceeds from step 936 to step 938; otherwise operation proceeds from step 936 to step 940. In step 936 the monitoring system implements the action(s) corresponding to the detected object, e.g. automatically close a door, automatically close a valve supplying gas, automatically close a valve supplying water, and/or generate an alert, e.g., a local alert at the monitored site, or send a message to a device, e.g., a cell phone or a computer of: the person residing at the monitored site, a relative of the person residing at the monitored site or designated contact, or a system, e.g., a firehouse system, a police dispatcher system, or an emergency responder system, alerting the device or the system of the detected condition(s). In step 940 the monitoring system continues monitoring without taking action. Operation proceeds from step 938 or step 940, via connecting node B 942 to step 904.

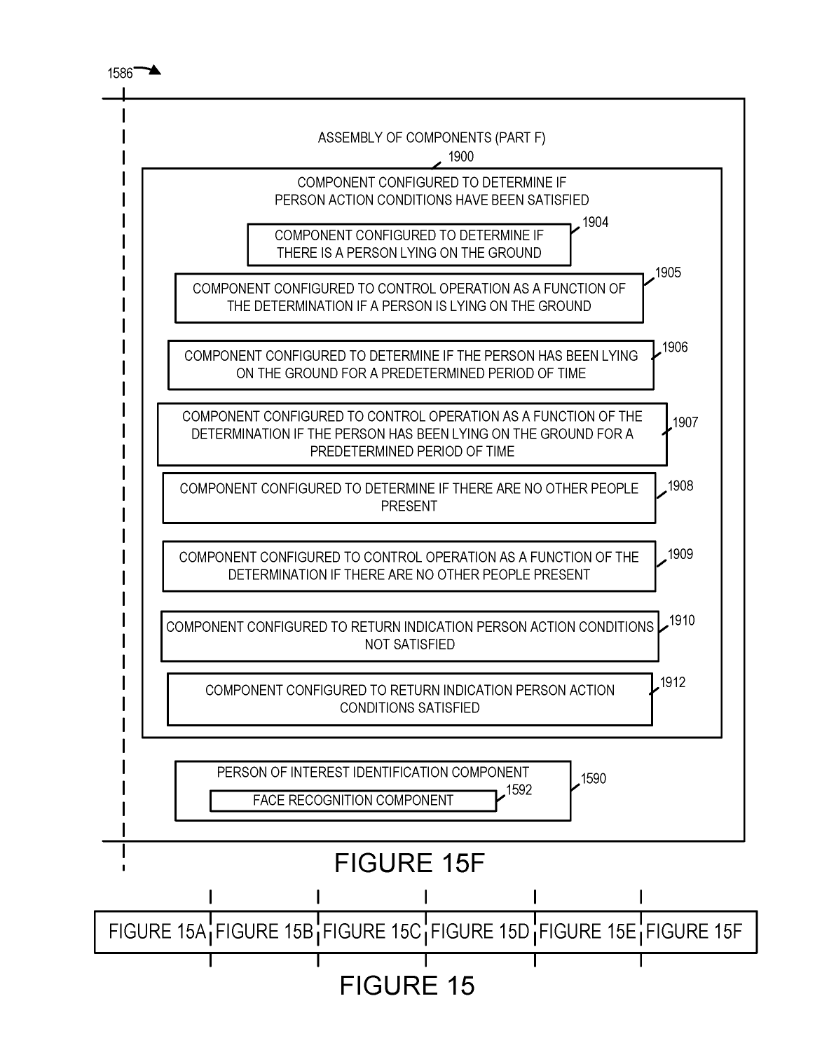

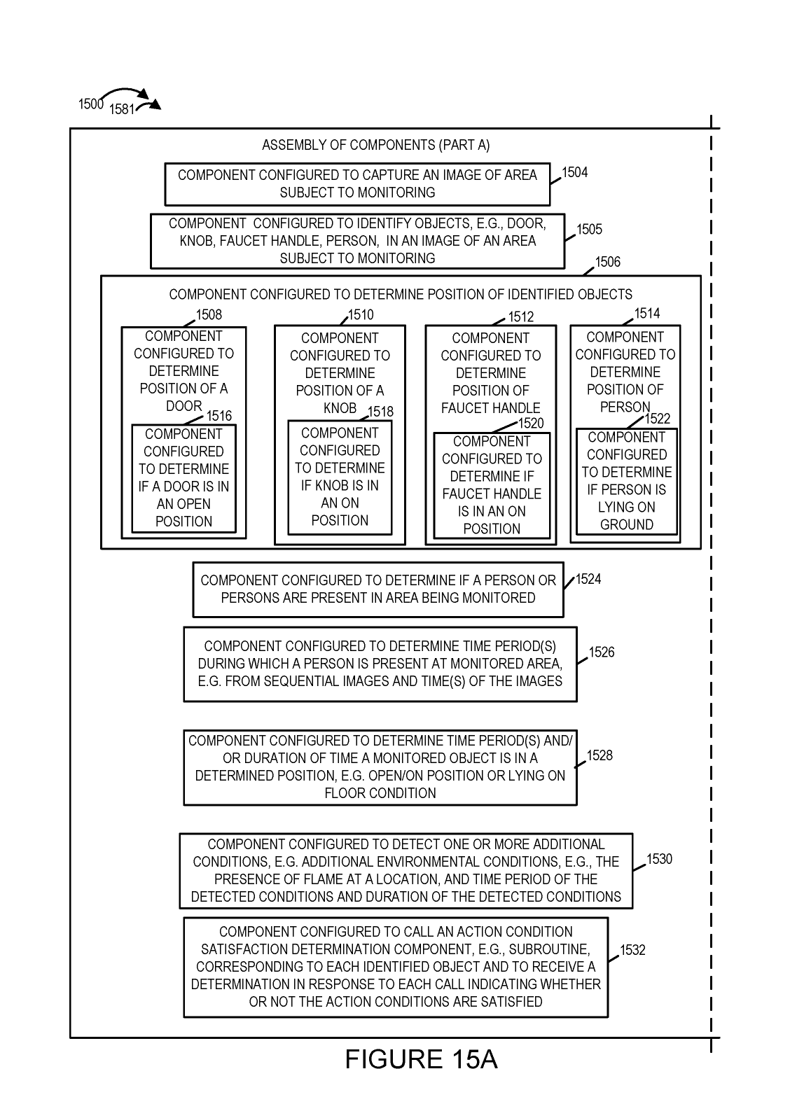

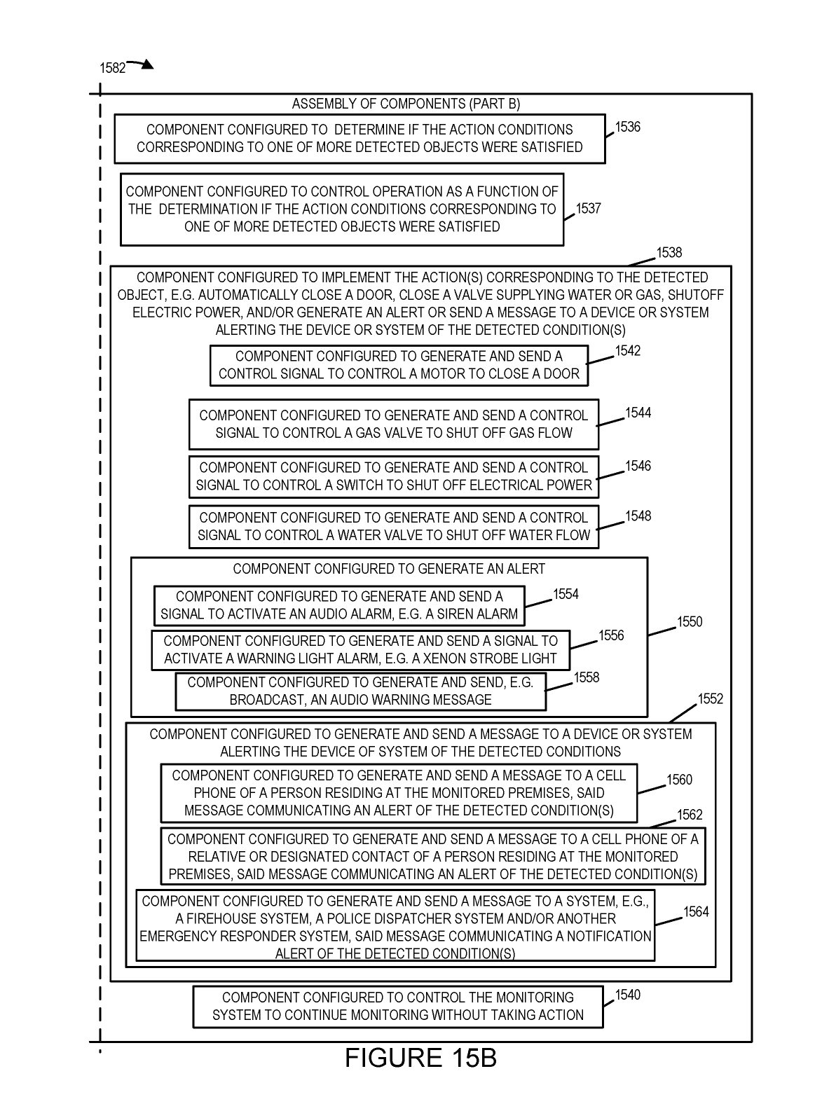

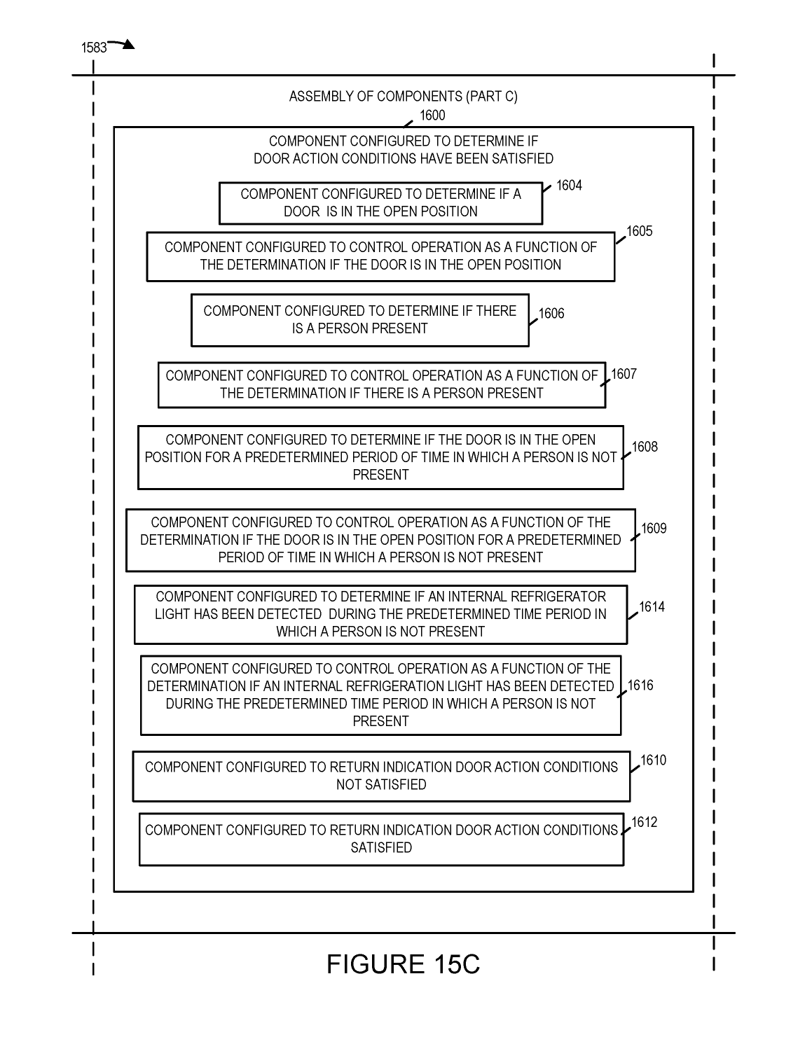

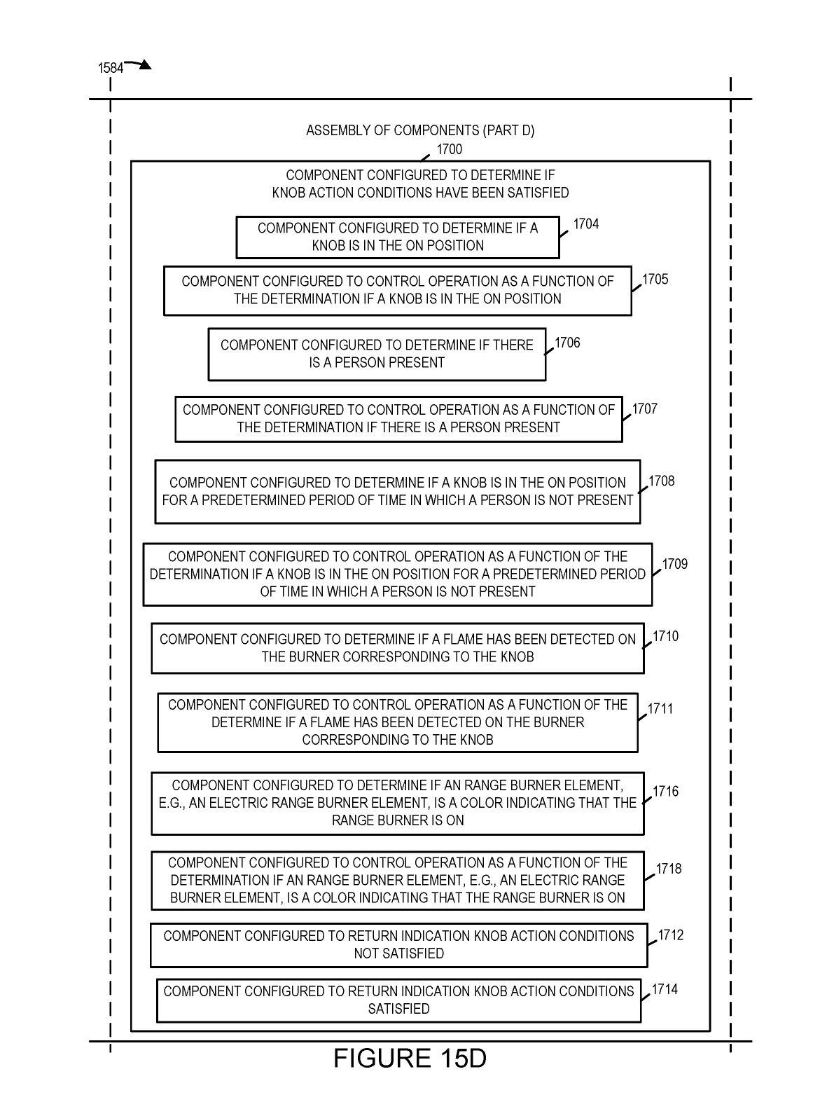

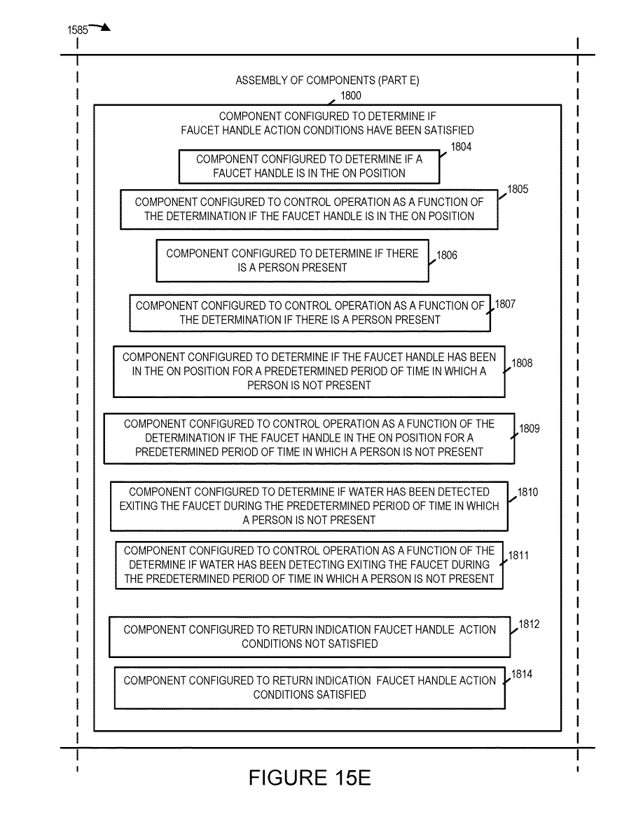

FIG. 15 is a drawing of an exemplary assembly of components 1500 which may be included in exemplary monitoring system, e.g., monitoring system 120 of FIG. 1 and/or monitoring system 800 of FIG. 8, in accordance with an exemplary embodiment. In some embodiments, assembly of components 1500 is implemented in access point 122 of FIG. 1. In some embodiments, portions of assembly of components 1500 are implemented in monitoring system 120 of FIG. 1, and portions of assembly of components 1500 are included in access point 122 of FIG. 1.

Assembly of components 1500 can be, and in some embodiments is, used in monitoring system 800, e.g., a monitoring device. In some embodiments monitoring system 800 of FIG. 8 is monitoring system 120 of FIG. 1. The components in the assembly of components 1500 can, and in some embodiments are, implemented fully in hardware within the processor 802, e.g., as individual circuits. The components in the assembly of components 1500 can, and in some embodiments are, implemented fully in hardware within the assembly of hardware components 804, e.g., as individual circuits corresponding to the different components. In other embodiments some of the components are implemented, e.g., as circuits, within the processor 802 with other components being implemented, e.g., as circuits within assembly of components 804, external to and coupled to the processor 802. As should be appreciated the level of integration of components on the processor and/or with some components being external to the processor may be one of design choice. Alternatively, rather than being implemented as circuits, all or some of the components may be implemented in software and stored in the memory 812 of the monitoring device 800, with the components controlling operation of device 800 to implement the functions corresponding to the components when the components are executed by a processor, e.g., processor 802. In some such embodiments, the assembly of components 1500 is included in the memory 812 as assembly of software components 820. In still other embodiments, various components in assembly of components 1500 are implemented as a combination of hardware and software, e.g., with another circuit external to the processor providing input to the processor 802 which then under software control operates to perform a portion of a component's function. While processor 802 is shown in the FIG. 8 embodiment as a single processor, e.g., computer, it should be appreciated that the processor 802 may be implemented as one or more processors, e.g., computers.

When implemented in software the components include code, which when executed by the processor 802, configure the processor 802 to implement the function corresponding to the component. In embodiments where the assembly of components 1500 is stored in the memory 812, the memory 812 is a computer program product comprising a computer readable medium comprising code, e.g., individual code for each component, for causing at least one computer, e.g., processor 802, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 15 control and/or configure the monitoring device 800 or elements therein such as the processor 802, to perform the functions of corresponding steps illustrated and/or described in the method of one or more of the flowcharts, signaling diagrams and/or described with respect to any of the Figures. Thus the assembly of components 1500 includes various components that perform functions of corresponding one or more described and/or illustrated steps of an exemplary method, e.g., one or more steps of the method of FIG. 7, FIG. 9, FIG. 10, FIG. 11, FIG. 12, and/or FIG. 13.

FIG. 15, comprising the combination of FIG. 15A, FIG. 15B, FIG. 15C, FIG. 15D, FIG. 15E and FIG. 15F, is a drawing of an assembly of components 1500, comprising the combination of Part A 1581, Part B 1582, Part C 1583, Part D 1584, Part E 1585, and Part F 1586, in accordance with an exemplary embodiment. Assembly of components 1500 includes a component 1502 configured to capture an image of an area subject to monitoring, a component 1505 configured to identify objects, e.g., a door, a knob, a faucet handle, a person, in an image of an area subject to monitoring, and a component 1506 configured to determine positions of identified objects. Component 1506 includes a component 1508 configured to determine position of a door, e.g., a refrigerator door, a component 1510 configured to determine position of a knob, e.g., a stove knob, a component 1512 configured to determine position of a faucet handle, and a component 1514 configured to determine position of a person.

In some embodiments, component 1510 is configured to determine the position of the knob to be one of an on position or an off position. In some embodiments, component 1512 is configured to determine the position of the faucet handle to be one of an on position or an off position. In some embodiments, component 1514 is configured to determine the position of the person to be one of lying on the ground or another position in the area subject to monitoring.

Component 1508 includes a component 1516 configured to determine if a door is in an open position. Component 1510 includes a component 1518 configured to determine if a knob is in an on position. Component 1512 includes a component 1516 configured to determine if a faucet handle is in an on position, e.g., an allow water flow position. Component 1514 includes a component 1522 configured to determine if a person is lying on the ground.

Assembly of components 1500 further includes a component 1524 configured to determine is a person or persons are present in an area being monitored, a component 1526 configured to determine time period(s) during which a person is present at monitored area(s), e.g., from sequential images and time(s) of the times, a component 1528 configured to determine time period(s) and/or duration of time a monitored object is in a determined position, e.g., open/on position or lying on the floor condition, a component 1530 configured to detect one or more additional conditions, e.g., additional environmental conditions, e.g., the presence or a flame at a location, the color of an electric burner element, the presence of water flowing from the outlet of the faucet, the detection of an internal refrigerator light, the presence of one or more additional persons in the monitored area, and time periods of the detected conditions and durations of the detected conditions.

Assembly of components 1500 further includes a component 1532 configured to call an action condition satisfaction determination component, e.g., subroutine, corresponding to each identified object and to receive a determination in response to each call, said determination indicating whether or not the action conditions are satisfied. Assembly of components 1500 further includes a component 1536 configured to determine if the action conditions corresponding to one or more detected objects were satisfied, a component 1537 configured to control operation as a function of the determination if the action conditions corresponding to one or more detected objects were satisfied, a component 1538 configured to implement the action(s) corresponding to the detected object, e.g., automatically close a door, automatically close a valve supplying water or gas, automatically shut off electric power, and/or generate an alert and/or send a message to a device or system alerting the device or system of the detected condition(s), e.g., in response to one or more set of actions condition being determined to be satisfied, and a component configured to control the monitoring system to continue monitoring without taking action, e.g., in response to none of the sets of action conditions being satisfied.

Component 1538 includes a component 1542 configured to generate and send a control signal to a motor to close a door, a component 1544 configured of generate and send a controil signal to control a gas valve to shut off gas flow, a component 1546 configured to generate and send a control signal to a switch to shut off electrical power, a component 1548 configured to generate and send a control signal to a water valve to shut off water flow. Component 1538 further includes a component 1550 configured to generate an alert, and a component 1552 configured to generate and send a message to a device or system alerting the device or system of the detection condition(s). Component 1550 includes a component 1554 configured to generate and send a signal to activate an audio alarm, e.g., a siren alarm, a component 1556 configured to generate and send a signal to activate a warning light alarm, e.g., a xenon strobe light, and a component 1558 configured to generate and send, e.g., broadcast, a warning message. Component 1552 includes a component 1560 configured to generate and send a message to a cell phone of a person residing at the monitored premises, said message communicating an alert of the detected condition(s), a component 1562 configured to generate and send a message to a cell phone of a relative or designated contact of a person residing at the monitored premises, said message communicating an alert of the detected condition(s), and a component 1564 configured to generate and send a message to a system, e.g., a firehouse system, a police dispatcher system, and/or another emergency responders system, said message communicating a notification alert of the detected condition(s).

Assembly of components 1500 further includes a component 1600 configured to determine if door action conditions have been satisfied, a component 1700 configured to determine if knob action conditions have been satisfied, a component 1800 configured to determine if faucet handle action conditions have been satisfied, and a component 1900 configured to determine if person action conditions have been satisfied. Component 1600 includes a component 1604 configured to determine if a door is in the open position, a component 1605 configured to control operation as a function of the determination if the door is in the open position, a component 1606 configured to determine if there is a person present, a component 1607 configured to control operation as a function of the determination if there is a person present, a component 1608 configured to determine if the door is in the open position for a predetermined period of time in which a person is not present, a component configured to control operation as a function of the determination if the door is in the open position for a predetermined period of time in which a person is not present, a component 1614 configured to determine if an internal refrigerator light has been detected during the predetermined time period in which a person is not present, a component configured to control operation as a function of the determination if an internal refrigerator light has been detected during the predetermined time period in which a person is not present. Component 1600 further includes a component 1610 configured to return an indication that the door action conditions are not satisfied, and a component 1612 configured to return an indication that the door actions conditions are satisfied.

Component 1700 includes a component 1704 configured to determine if a knob is in the on position, a component 1705 configured to control operation as a function of the determination if the knob is in the on position, a component 1706 configured to determine if there is a person present, a component 1707 configured to control operation as a function of the determination if there is a person present, a component 1708 configured to determine if the knob is in the on position for a predetermined period of time in which a person is not present, a component 1709 configured to control operation as a function of the determination if the knob is in the on position for a predetermined period of time in which a person is not present, a component 1710 configured to determine if a flame has been detected on the burner corresponding to the knob, and a component 1711 configured to control operation as a function of the determination if a flame has been detected on the burner corresponding to the knob component, a component 1716 configured to determine if a range burner element, e.g., an electric range burner element, is a color indicating that the range burner is on, and a component 1718 configured to control operation as a function of the determination if the range burner element, e.g., the electric range burner element, is a color indicating that the range burner is on. Component 1700 further includes a component 1712 configured to return an indication that the knob, e.g., stove knob, action conditions are not satisfied, and a component 1714 configured to return an indication that the knob, e.g., stove knob, actions conditions are satisfied.

Component 1800 includes a component 1804 configured to determine if a faucet handle is in the open position, a component 1805 configured to control operation as a function of the determination if the faucet handle is in the open position, a component 1806 configured to determine if there is a person present, a component 1807 configured to control operation as a function of the determination if there is a person present, a component 1808 configured to determine if the faucet handle is in the open position for a predetermined period of time in which a person is not present, a component 1809 configured to control operation as a function of the determination if the faucet handle is in the open position for a predetermined period of time in which a person is not present, a component 1810 configured to determine if water, e.g., a stream of water, has been detected exiting the faucet during the predetermined time period in which a person is not present, a component 1811 configured to control operation as a function of the determination if water, e.g., if a stream of water, has been detected exiting the faucet during the predetermined time period in which a person is not present. Component 1800 further includes a component 1812 configured to return an indication that the faucet handle action conditions are not satisfied, and a component 1814 configured to return an indication that the faucet handle actions conditions are satisfied.

Component 1900 includes a component 1904 configured to determine if there is a person lying on the ground, a component 1905 configured to control operation as a function of the determination if there is a person lying on the ground, a component 1906 configured to determine if there is the person has been lying on the ground for a predetermined period of time, a component 1907 configured to control operation as a function of the determination if the person has been lying on the ground for a predetermined period of time, a component 1908 configured to determine if there are no other people present, a component 1909 configured to control operation as a function of the determination if there are no other people present. Component 1900 further includes a component 1910 configured to return an indication that the person action conditions are not satisfied, and a component 1912 configured to return an indication that the person actions conditions are satisfied.

Assembly of components 1500 further includes a person of interest identification component 1590 configured to identify a particular person on interest, e.g., determine the identity of a person detected to be lying on the ground for a predetermined time period based on visual observations of the detected person and stored sets of information, e.g., physical characteristics such as face pattern, hair color, size, etc. corresponding to each one or more potential persons of interest residing at the monitored site. Person of interest identification component includes a face recognition component 1592.

Set forth below are various exemplary numbered embodiments. Each set of numbered exemplary embodiments is numbered by itself with embodiments in a set referring to previous numbered embodiments in the same set.

### List of Set of Exemplary Numbered Method Embodiments

### Method Embodiment 1

A method, comprising: identifying objects (e.g., door, knob, person, faucet handle) in an image of an area subject to monitoring; determining a current position of at least a first identified object to be monitored; determining if the current position of the first identified object to be monitored is in a first position, said first position being a position in response to which an action is to be taken if first action conditions are satisfied; determining if the first action conditions are satisfied; and in response to determining that the first identified object to be monitored is in the first position and that the first action conditions are satisfied, performing at least one of: i) taking an action to alter a condition at the area subject to monitoring (e.g., automatically operate an electronic water/gas shut off value shutting of supply of water or gas to a house or device or automatically operate an switch to shut off power to a house, line or device, or automatically operate a motor to close a door) or ii) generating an alert.

### Method Embodiment 2

The method of method embodiment 1, further comprising: capturing (e.g., prior to the step of identifying objects) an image of an area subject to monitoring.

### Method Embodiment 3

The method of method embodiment 1, further comprising: determining the position of identified objects subject to monitoring; and wherein determining the current position of at least a first identified object to be monitored is performed as part of said step of determining the position of identified object subject to monitoring.

### Method Embodiment 4

The method of method embodiment 2, wherein identified objects subject to monitoring include one or more of: a door, a knob, a faucet handle, or a person.

### Method Embodiment 5

The method of method embodiment 3, wherein the first identified object to be monitored is a door (e.g., of a refrigerator potentially with a motor that can be used to close the door); and wherein determining if the current position of the first identified object to be monitored is in a first position includes determining if the door is in an open position.

### Method Embodiment 6

The method of method embodiment 5, wherein the first action conditions include the door being open for a first period of time; and wherein determining if the first action conditions are satisfied includes determining if the door has been open for the first period of time.

### Method Embodiment 7

The method of method embodiment 6, wherein the first action conditions further include a person not being present in the area subject to monitoring for said first period of time.

### Method Embodiment 8

The method of method embodiment 3, wherein the first identified object to be monitored is a knob (e.g., of a gas stove); and wherein determining if the current position of the first identified object to be monitored is in a first position includes determining if the knob is in an on position.

### Method Embodiment 9

The method of method embodiment 8, wherein the first action conditions include the knob being in the on position for a first period of time; and wherein determining if the first action conditions are satisfied includes determining if the knob has been in the on position for the first period of time.

### Method Embodiment 10

The method of method embodiment 9, wherein the first action conditions further include a person not being present in the area subject to monitoring for said first period of time during which the knob has been in the on position.

### Method Embodiment 11

The method of method embodiment 3, wherein determining the position of identified objects subject to monitoring includes determining the position of a knob to be one of an on position or an off position.

### Method Embodiment 12

The method of method embodiment 3, wherein determining the position of identified objects subject to monitoring includes determining the position of a faucet handle to be one of an on position or an off position.

### Method Embodiment 13

The method of method embodiment 3, wherein determining the position of identified objects subject to monitoring includes determining the position of a person, said position of the person being one of a position of a person lying on the ground or another position in the area subject to be monitoring.

### List of Set of Exemplary Numbered Apparatus Embodiments

### Apparatus Embodiment 1

A monitoring apparatus, comprising: a processor configured to: identify objects (e.g., door, knob, person, faucet handle) in an image of an area subject to monitoring; determine a current position of at least a first identified object to be monitored; determine if the current position of the first identified object to be monitored is in a first position, said first position being a position in response to which an action is to be taken if first action conditions are satisfied; determine if the first action conditions are satisfied; and in response to determining that the first identified object to be monitored is in the first position and that the first action conditions are satisfied, performing at least one of: i) taking an action to alter a condition at the area subject to monitoring (e.g., automatically operate an electronic water/gas shut off value shutting of supply of water or gas to a house or automatically operate a motor for closing a door) or ii) generating an alert; and memory coupled to said processor.

### Apparatus Embodiment 2

The monitoring apparatus of apparatus embodiment 1, wherein said processor is further configured to: control a camera to capture (e.g., prior to the step of identifying objects) an image of an area subject to monitoring.

### Apparatus Embodiment 3

The monitoring apparatus of apparatus embodiment 1, wherein said processor is further configured to: determine the position of identified objects subject to monitoring; and wherein determining the current position of at least a first identified object to be monitored is performed as part of said step of determining the position of identified object subject to monitoring.

### Apparatus Embodiment 4

The monitoring apparatus of apparatus embodiment 2, wherein identified objects subject to monitoring include one or more of: a door, a knob, a faucet handle, or a person.

### Apparatus Embodiment 5

The monitoring apparatus of apparatus embodiment 3, wherein the first identified object to be monitored is a door (e.g., of a refrigerator potentially with a motor that can be used to close the door); and wherein said processor is configured to: determine if the door is in an open position, as part of being configured to determine if the current position of the first identified object to be monitored is in a first position.

### Apparatus Embodiment 6

The monitoring apparatus of apparatus embodiment 5, wherein the first action conditions include the door being open for a first period of time; and wherein said processor is configured to determining if the door has been open for the first period of time, as part of being configured to determine if the first action conditions are satisfied.

### Apparatus Embodiment 7

The monitoring apparatus of apparatus embodiment 6, wherein the first action conditions further include a person not being present in the area subject to monitoring for said first period of time.

### Apparatus Embodiment 8

The monitoring apparatus of apparatus embodiment 3, wherein the first identified object to be monitored is a knob (e.g., of a gas stove); and wherein said processor is configured to determine if the knob is in an on position as part of being configured to determine if the current position of the first identified object to be monitored is in a first position.

### Apparatus Embodiment 9

The monitoring apparatus of apparatus embodiment 8, wherein the first action conditions include the knob being in the on position for a first period of time; and wherein said processor is configured to determine if the knob has been in the on position for the first period of time, as part of being configured to determine if the first action conditions are satisfied.

### Apparatus Embodiment 10

The monitoring apparatus of apparatus embodiment 9, wherein the first action conditions further include a person not being present in the area subject to monitoring for said first period of time during which the knob has been in the on position.

### Apparatus Embodiment 11

The monitoring apparatus of apparatus embodiment 3, wherein said processor is configured to determine the position of a knob to be one of an on position or an off position, as part of being configured to determine the position of identified objects subject to monitoring.

### Apparatus Embodiment 12

The monitoring apparatus of apparatus embodiment 3, wherein said processor is configured to determine the position of a faucet handle to be one of an on position or an off position as part of being configured to determine the position of identified objects subject to monitoring.

### Apparatus Embodiment 13

The monitoring apparatus of apparatus embodiment 3, wherein said processor is configured to determine the position of a person, said position of the person being one of a position of a person lying on the ground or another position in the area subject to be monitoring, as part of being configured to determine the position of identified objects subject to monitoring.

### Computer Readable Medium Embodiment

A non-transitory computer readable medium including processor executable instructions which, when executed by a processor of a monitoring apparatus, control the monitoring apparatus to perform the steps of: identifying objects (e.g., door, knob, person, faucet handle) in an image of an area subject to monitoring; determining a current position of at least a first identified object to be monitored; determining if the current position of the first identified object to be monitored is in a first position, said first position being a position in response to which an action is to be taken if first action conditions are satisfied; determining if the first action conditions are satisfied; and in response to determining that the first identified object to be monitored is in the first position and that the first action conditions are satisfied, performing at least one of: i) taking an action to alter a condition at the area subject to monitoring (e.g., automatically operate an electronic water/gas shut off value shutting of supply of water or gas to a house or device or automatically operate an switch to shut off power to a house, line or device, or automatically operate a motor to close a door) or ii) generating an alert.

What is claimed is:

1. A method, comprising:
identifying objects in an image of an area subject to monitoring;
determining a current position of at least a first identified object to be monitored;
determining if the current position of the first identified object to be monitored is in a first position, said first position being a position in response to which an action is to be taken if first action conditions are satisfied;
determining if the first action conditions are satisfied; and
in response to determining that the first identified object to be monitored is in the first position and that the first action conditions are satisfied, performing at least one of: i) taking an action to alter a condition at the area subject to monitoring or ii) generating an alert.

2. The method of claim 1, further comprising:
capturing an image of an area subject to monitoring.

3. The method of claim 1, further comprising:
determining the position of identified objects subject to monitoring; and
wherein determining the current position of at least a first identified object to be monitored is performed as part of said step of determining the position of identified object subject to monitoring.

4. The method of claim 2, wherein identified objects subject to monitoring include one or more of: a door, a knob, a faucet handle, or a person.

5. The method of claim 3,
wherein the first identified object to be monitored is a door; and
wherein determining if the current position of the first identified object to be monitored is in a first position includes determining if the door is in an open position.

6. The method of claim 5,
wherein the first action conditions include the door being open for a first period of time; and
wherein determining if the first action conditions are satisfied includes determining if the door has been open for the first period of time.

7. The method of claim 6, wherein the first action conditions further include a person not being present in the area subject to monitoring for said first period of time.

8. The method of claim 3,
wherein the first identified object to be monitored is a knob; and
wherein determining if the current position of the first identified object to be monitored is in a first position includes determining if the knob is in an on position.

9. The method of claim 8,
wherein the first action conditions include the knob being in the on position for a first period of time; and
wherein determining if the first action conditions are satisfied includes determining if the knob has been in the on position for the first period of time.

10. The method of claim 9, wherein the first action conditions further include a person not being present in the area subject to monitoring for said first period of time during which the knob has been in the on position.

11. The method of claim 3, wherein determining the position of identified objects subject to monitoring includes determining the position of a knob to be one of an on position or an off position.

12. The method of claim 3, wherein determining the position of identified objects subject to monitoring includes determining the position of a faucet handle to be one of an on position or an off position.

13. The method of claim 3, wherein determining the position of identified objects subject to monitoring includes determining the position of a person, said position of the person being one of a position of a person lying on the ground or another position in the area subject to be monitoring.

14. A monitoring apparatus, comprising:
a processor configured to:
identify objects in an image of an area subject to monitoring;
determine a current position of at least a first identified object to be monitored;
determine if the current position of the first identified object to be monitored is in a first position, said first position being a position in response to which an action is to be taken if first action conditions are satisfied;
determine if the first action conditions are satisfied; and
in response to determining that the first identified object to be monitored is in the first position and that the first action conditions are satisfied, performing at least one of: i) taking an action to alter a condition at the area subject to monitoring or ii) generating an alert; and
memory coupled to said processor.

15. The monitoring apparatus of claim 14, wherein said processor is further configured to:
control a camera to capture an image of an area subject to monitoring.

16. The monitoring apparatus of claim 14, wherein said processor is further configured to:
determine the position of identified objects subject to monitoring; and
wherein determining the current position of at least a first identified object to be monitored is performed as part of said step of determining the position of identified object subject to monitoring.

17. The monitoring apparatus of claim 16,
wherein the first identified object to be monitored is a door; and
wherein said processor is configured to: determine if the door is in an open position, as part of being configured to determine if the current position of the first identified object to be monitored is in a first position.

18. The monitoring apparatus of claim 17,
wherein the first action conditions include the door being open for a first period of time; and
wherein said processor is configured to determining if the door has been open for the first period of time, as part of being configured to determine if the first action conditions are satisfied.

19. The monitoring apparatus of claim 18, wherein the first action conditions further include a person not being present in the area subject to monitoring for said first period of time.

20. A non-transitory computer readable medium including processor executable instructions which, when executed by a processor of a monitoring apparatus, control the monitoring apparatus to perform the steps of:
identifying objects in an image of an area subject to monitoring; determining a current position of at least a first identified object to be monitored;
determining if the current position of the first identified object to be monitored is in a first position, said first position being a position in response to which an action is to be taken if first action conditions are satisfied;
determining if the first action conditions are satisfied; and in response to determining that the first identified object to be monitored is in the first position and that the first action conditions are satisfied, performing at least one of: i) taking an action to alter a condition at the area subject to monitoring or ii) generating an alert.
